(19) United States
(12) Patent Application Publication
(10) Pub. No.: US 2006/0209019 A1
(43) Pub. Date: Sep. 21, 2006

(54) Magnetic haptic feedback systems and methods for virtual reality environments

(75) Inventor: Jianjuen Hu, Boxborough, MA (US)

Correspondence Address: BANNER & WITCOFF, LTD., 28 STATE STREET, 28th FLOOR, BOSTON, MA, 02109-9601, US

(73) Assignee: Energid Technologies Corporation, Cambridge, MA (US)

(21) Appl. No.: 11/141,828

(22) Filed: Jun. 1, 2005

Related U.S. Application Data
(60) Provisional application No. 60/575,190, filed on Jun. 1, 2004.

(51) Int. Cl. G09G 5/00

(52) U.S. Cl. 345/156

(57) ABSTRACT

A haptic feedback system comprises a moveable device with at least three degrees of freedom in an operating space. A display device is operative to present a dynamic virtual environment. A controller is operative to generate display signals to the display device for presentation of a dynamic virtual environment corresponding to the operating space, including an icon corresponding to the position of the moveable device in the virtual environment. An actuator of the haptic feedback system comprises a stator having an array of independently controllable electromagnet coils. By selectively energizing at least a subset of the electromagnetic coils, the stator generates a net magnetic force on the moveable device in the operating space. In certain exemplary embodiments the actuator has a controllably moveable stage positioning the stator in response to movement of the moveable device, resulting in a larger operating area. A detector of the system, optionally multiple sensors of different types, is operative to detect at least the position of the moveable device in the operating space and to generate corresponding detection signals to the controller. The controller receives and processes detection signals from the detection sensor and generates corresponding control signals to the actuator to control the net magnetic force on the moveable device.

### CLAIM FOR PRIORITY BENEFIT

This patent application claims the priority benefit of U.S. Provisional Patent Application Ser. No. 60/575,190 filed on Jun. 1, 2004, entitled Maglev-Based Haptic Feedback System.

### STATEMENT REGARDING FEDERALLY SPONSORED RESEARCH AND DEVELOPMENT

The invention was supported in part by the Department of the Army under contract W81XWH-04-C-0048. The U.S. Government has certain rights in the invention.

### INTRODUCTION

This patent application discloses and claims inventive subject matter directed to systems and methods for displaying a virtual environment with haptic feedback to a moveable device moving in an operating space corresponding to the virtual environment.

### BACKGROUND

Virtual environment systems create a computer-generated virtual environment that can be visually or otherwise perceived by a human or animal user(s). The virtual environment is created by a remote or on-site system computer through a display screen, and may be a presented as two-dimensional (2D) or three-dimensional (3D) images of a work site or other real or imaginary location. The location or orientation of an item, such as a work tool or the like held or otherwise supported by or attached to the user is tracked by the system. The representation is dynamic in that the virtual environment can change corresponding to movement of the tool by the user. The computer generated images may be of an actual or imaginary place, e.g., a fantasy setting for an interactive computer game, a body or body part, e.g., an open body cavity of a surgical patient or a cadaver for medical training, a virtual device being assembled of virtual component parts, etc.

Systems are known, sometimes referred to as maglev systems, which use magnetic forces on objects, e.g. to control the position of an object or to simulate forces on the object in a virtual environment. As used here, a maglev system does not necessarily have the capacity to generate magnetic forces sufficient independently to levitate or lift the object against the force of gravity. Similarly, maglev forces are not necessarily of a magnitude sufficient to hold the object suspended against the force of gravity. Rather, in the context of the haptic feedback systems discussed here, maglev forces should be understood to be magnetic (typically electromagnetic) forces generated by the system to apply at least a biasing force on the object, which can be perceived by the user and controlled by the system to be repulsive or attractive. In certain such systems, for example, U.S. Pat. No. 6,704,001 to Schena et al., a magnetic hand tool is mounted to an interface device with at least one degree of freedom (DOF), e.g., a linear motion DOF or a rotational DOF. The magnetic hand tool is tracked, e.g., by optical sensor, as it is moved by the user. Magnetic forces on the hand tool, sufficient to be perceived by the user, are generated to simulate interaction of the hand tool with a virtual condition, i.e., an event or interaction of the hand tool within a graphical (imaginary) environment displayed by a host computer. Data from the sensor are used to update the graphical environment displayed by the host computer. Systems are known, such as in The Actuated Workbench: Computer-Controlled Actuation in Tabletop Tangible Interfaces, Pangaro et al., Proceedings of UIST 2002 (Oct. 27-30, 2002), which use magnetic forces to move objects on a tabletop surface. The position or motion of the objects is tracked by sensors. In surgery simulation, systems have applied haptic devices to provide force feedback to trainees. For example, small size robot arm-like haptic input devices, such as Sensable Technologies' PHANToM, have been used successfully in tethered surgery simulations (laparoscopic surgery and endoscopic surgery etc.). Also, Simquest and Intuitive Surgical are playing a big role in developing open surgery simulators. Simquest has done development in the areas of surgery validation, evaluation metrics development, and surgery simulation. The surgery simulation approach of Simquest is mainly to use image based visualization and animation. Haptic device and force feedback is optional. Intuitive Surgical has done surgical robotic system development and surgery simulation has been one of its research areas. Intuitive Surgical has development an eight DOF robotic device for medical application, called the Da Vinci system. The Da Vinci master robot can be converted to a force feedback device in surgery simulation. However, it is limited in open surgery simulation since it is a tethered device (i.e., it is mounted and so, restricted in its movement), which is similar to other conventional haptic input devices, such as Sensable Technologies' PHANToM and MPB Technologies' Freedom 6S etc.

Product prototypes of maglev haptic input devices are believed to include at least two whose designs are similar in structures, design concept and core technology. The designers were with CMU RI (robotic institute) or are affiliated with CMU RI. One such item is a maglev joystick referred to as the CMU magletic levitation haptic device. The other is a magnetic power mouse from the University of British Columbia. These products are believed to share the same patents on maglev haptic interface, specifically, U.S. Pat. No. 4,874,998 to Hollis et al., entitled Magnetically Levitated Fine Motion Robot Wrist With Programmable Compliance, and U.S. Pat. No. 5,146,566 to Hollis et al., entitled Input/Output System For Computer User Interface Using Magnetic Levitation, both of which are incorporated here by reference in their entirety for all purposes.

Existing systems suffer deficiencies or disadvantages for various applications. In all or at least some applications, it would be advantageous to have a large area of motion for a hand tool or other moveable device, while remaining within range of the maglev forces generated by the system. In addition, especially for systems in which the hand tool represents an actual device, e.g., a scalpel or other surgical implement in a surgical simulation system, greater accuracy or realism is desired in the feel of the hand tool moving through space. Accordingly, it is an object of at least certain embodiments of the systems and methods disclosed here for displaying a virtual environment with haptic feedback to a moveable device, to provide improvement in one or more of these aspects.

Additional objects and advantages of all or certain embodiments of the systems and methods disclosed here will be apparent to those skilled in the art given the benefit of the following disclosure and discussion of certain exemplary embodiments.

### SUMMARY

In accordance with a first aspect, virtual environment systems and methods having haptic feedback comprise a magnetically-responsive, device which during movement in an operating space or area, is tracked or otherwise detected by a detector, e.g., one or more sensors, e.g., a camera or other optical sensors, Hall Effect sensors, accelerometers on-board the movable device, etc., and is subjected to haptic feedback comprising magnetic force (optionally referred to here as maglev force) from an actuator. The operating area corresponds to the virtual environment displayed by a display device, such that movement of the moveable device in the operating area by a user or operator can, for example, can be displayed as movement in or action in or on the virtual environment. In certain exemplary embodiments the moveable device corresponds to a feature or device shown (as an icon or image) in the virtual environment, e.g., a virtual hand tool or work piece or game piece in the virtual environment, as further described below.

The moveable device is moveable with at least three degrees of freedom in the operating space. In certain exemplary embodiments the moveable device has more than 3 DOF and in certain exemplary embodiments the moveable device is untethered, meaning it is not mounted to a supporting bracket or armature of any kind during use, and so has six DOF (travel along the X, Y and Z axes and rotation about those axes). The moveable device is magnetically responsive, e.g., all or at least a component of the device comprises iron or other suitable material that can be attracted magnetically and/or into which a temporary magnetism can be impressed. In certain exemplary embodiments the moveable device comprises a permanent magnet. The operating space of the systems and methods disclosed here may or may not have boundaries or be delineated in free space in any readily perceptible manner other than by reference to the virtual environment display or to the operative range of maglev haptic forces. For convenience an “untethered” moveable device of a system or method in accordance with the present disclosure may be secured against loss by a cord or the like which does not significantly restrict its movement. Such cord also may carry power, data signals or the like between the moveable device and the controller or other device. In certain exemplary embodiments the moveable device may be worn or otherwise deployed.

A display device of the systems and methods disclosed here is operative to present or otherwise display a dynamic virtual environment corresponding at least partly to the operating space. The dynamic virtual environment is said here to correspond at least partly to the operating space (or for convenience is said here to correspond to the operating space) in that at least part of the operating space corresponds to at least part of the virtual environment displayed. Thus, the real and the virtual spaces overlap entirely or in part. Real space “corresponds to virtual space,” as that term is used here, if movement of the moveable device in such real space shows as movement of the aforesaid icon in the virtual space and/or movement of the moveable device in the real space is effective to cause a (virtual) change in that virtual space. The display device is operative at least in part to display signals to present a dynamic virtual environment corresponding to the operating space. That is, in certain exemplary embodiments the dynamic virtual environment is generated or presented by the display device based wholly on display signals from the controller. In other exemplary embodiments the dynamic virtual environment is generated or presented by the display device based partly on display signals from the controller and partly on other sources, e.g., signals from other devices, pre-recorded images, etc. The virtual environment presented by the display device is dynamic in that it changes with time and/or in response to movement of the moveable device through the real-world operating space corresponding to the virtual environment. The display device may comprise any suitable projector, screen, etc. such as, e.g., an LDC, CRT or plasma screen or may be created by holographic display or the like, etc. In certain exemplary embodiments the display device is operative to present the virtual environment with autostereoscopy 3D technology, e.g., HOLODECK VOLUMETRIC IMAGER (HVI) available from Holoverse Group (Cambridge, Mass.) and said to be based on TEXAS INSTRUMENTS' DMD™ Technology; 3D autostereoscopy displays from Actuality Systems, Inc. (Burlington, Mass.) or screens for stereoscopic projection or visualization available from Sharp Laboratories of Europe Limited. In certain exemplary embodiments a 2D or 3D virtual environment is displayed by a helmet or goggle display system worn by the user. The virtual environment presented by the display device includes a symbol or representation of the moveable device. For example, such symbol or representation, in some instances referred to here and in the claims as an icon, may be an accurate image of the moveable device, e.g., an image stored in the controller or a video image fed to the display device from the detector (if the detector has such video capability), or a schematic or other symbolic image. That is, the display device displays an icon in the virtual environment that corresponds to the moveable device in the 3D or 2D operating area. Such icon is included in the virtual environment displayed by the display device at a position in the virtual environment that corresponds to the actual position of the moveable object in the operating space. Movement of the moveable device in the operating area results in corresponding movement of the icon in the displayed virtual environment.

A controller of the systems and methods disclosed here is operative to receive signals from the detector mentioned above (optionally referred to here as detection signals), corresponding to the position or movement of the moveable device, and to generate corresponding signals (optionally referred to as display signals) to the display device and to an actuator described below. The signals to the display device include at least signals for displaying the aforesaid icon in the virtual environment and, in at least certain exemplary embodiments for updating the virtual environment, e.g., its condition, features, location, etc. The signals from the controller to the actuator include at least signals (optionally referred to as haptic force signals) for generation of maglev haptic feedback force by a stator of the actuator and, in at least certain exemplary embodiments wherein the actuator comprises a mobile stage, to generate signals (optionally referred to as actuator control signals) to at least partially control movement of such stator by the actuator. The controller is thus operative at least to control (partially or entirely) the actuator described below for generating haptic feedback force on the magnetically responsive moveable device and the display system. In certain exemplary embodiments the controller is also operative to control at least some aspects of the detector described below, e.g., movement of the detector while tracking the position or movement of the moveable device or otherwise detecting (e.g., searching for) the moveable device. The controller in at least certain exemplary embodiments is also operative to control at least some aspects of other components or devices of the system, if any. The controller comprises a single computer or any suitable combination of computers, e.g., a centralized or distributed computer system which is in electronic, optical or other signal communication with the display device, the actuator and the detector, and in certain exemplary embodiments with other components or devices. In at least certain exemplary embodiments the computer(s) of the controller each comprises a CPU operatively communicative via one or more I/O ports with the other components just mentioned, and may comprise, e.g., one or more laptop computers, PCs, and/or microprocessors carried on-board the display device, detector, actuator and/or other component(s) of the system. The controller, therefore, may be a single computer or multiple computers, for example, one or more microprocessors onboard or otherwise associated with other components of the system. In certain exemplary embodiments the controller comprises one or more IBM compatible PCs packaged, for example, as laptop computers for mobility. Communication between the controller and other components of the system, e.g., for communication of detection signals from the detector to the controller, for communication of haptic force signals or actuator control signals from the controller to the actuator, for communication of display signals from the controller to the display device, and/or for other communication, may be wired or wireless. For example, in certain exemplary embodiments signals may be communicated over a dedicated cable or wire feed to the controller or other system component. In certain other exemplary embodiments wireless communication is employed, optionally with encryption or other security features. In certain exemplary embodiments communication is performed wholly or in part over the internet or other network, e.g., a wide area network (WAN) or local area network (LAN).

As indicated above, virtual environment systems and methods disclosed here have an actuator. The actuator comprises a stator and in certain exemplary embodiments further comprises a mobile stage. The stator comprises an array of electromagnet coils at spaced locations, e.g., at equally spaced locations in a circle or the like on a spherical or parabolic concave surface, or cubic surface of the stator. In certain exemplary embodiments the stator has 3 coils, in other embodiments 4 coils, in other embodiments 5 coils and in other embodiments 6 or more coils. The stator is operative by energizing one or all of the coils, e.g., by selectively energizing a subset (e.g., one or more) of the electromagnet coils in response to haptic force signals from at least the controller, to generate a net magnetic force on the moveable device in the operating space. The net magnetic force is the effective cumulative maglev force applied to the movable device by energizing the electromagnet coils. The net magnetic force may be attractive or, in at least certain exemplary embodiments it may be repulsive. It may be static or dynamic, i.e., it may over some measurable time period be changing or unchanging in strength and/or vector characteristics. It may be constant or changing with change of position (meaning change of location and/or change of orientation or the like) of the moveable device in the operating space. At least some of the electromagnet coils are independently controllable, at least in the sense that each can be energized whether or not others of the coils are energized, and at a power level that is the same as or different from others of the coils in order to achieve at any given moment the desired strength and vector characteristics of the net magnetic force applied to the moveable device. A coil is independently controllable as that term is used here notwithstanding that its actuation power level may be calculated, selected or otherwise determined (e.g., iteratively) with reference to that of other coils of the array. The actuator may be permanently or temporarily secured to the floor or to the ground at a fixed position during use or it may be moveable over the ground. In either case, the actuator in certain exemplary embodiments comprises a mobile stage operative to move the stator during use of the system. Such mobile stage comprises a mounting point for the stator, e.g., a bracket or the like, referred to here generally as a support point, controllably moveable in at least two dimensions and in certain exemplary embodiments three dimensions. In certain exemplary embodiments the mobile stage is an X-Y-Z table operative to move the stator up and down, left and right, and fore and aft, or more degree of freedom can be added such as tip and tilt. The position of the support point along each axis is independently controllable at least in the sense that the support can be moved simultaneously (or in some embodiments sequentially) along all or a portion of the travel range of any one of the three axes irrespective of the motion or position along either or both of the other axes.

The term “independently controllable” does not require, however, that the movement in one direction (e.g., the X direction) be calculated or controlled without reference or consideration of the other directions (e.g., the Y and Z directions). In certain exemplary embodiments the mobile stage can also provide rotational movement of the stator about one, two or three axes.

As indicated above, virtual environment systems and methods disclosed here have a detector that is operative to detect at least the position of the moveable device in the operating space and to generate corresponding detection signals to the controller. The detector may comprise, for example, one or more optical sensors, such as cameras, one or more Hall Effect sensors, accelerometers, etc. As used here, the term “position” is used to mean the relationship of the moveable object to the operating space and, therefore, to the virtual environment, including either or both location and orientation of the moveable object. In certain exemplary embodiments the “position” of the moveable device as that term is used here means its location in the operating space, in certain exemplary embodiments it means its orientation, and in certain exemplary embodiments it means both and/or either. Thus, detecting the position of the moveable object means detecting its position relative to a reference point inside or outside the operating space, detecting its movement in the operating space, detecting its orientation or change in orientation, calculating position or orientation (or change in either) based on other sensor information, and/or any other suitable technique for determining the position and/or orientation of the moveable object in the operating space. Determining the position of the moveable object in the operating space facilitates the controller generating corresponding display signals to the display device, so that the icon (if any) representing the moveable device in the virtual environment presented by the display device can be correctly positioned in the virtual environment as presented by the display device in response to display signals from the controller. Also, this enables the system controller to determine the interactions (optionally referred to here as virtual interactions) if any, that the moveable device is having with features (optionally referred to here as virtual features) in the virtual environment as a result of movement of the moveable device and/or changes in the virtual environment, and to generate signals for corresponding magnetic forces on the moveable device to simulate the feeling the user would have if the virtual interactions were instead real. Thus, the controller is operative to receive and process detection signals from the detector and to generate corresponding control signals to the actuator to control generation of dynamic maglev forces on the moveable device.

In accordance with a method aspect, a dynamic virtual environment is presented to a user of a system as disclosed above, and maglev haptic feedback forces are generated by the system on the magnetically responsive moveable device positioned by or otherwise associated with the user in an operating space. In at least certain exemplary embodiments the position of the device is shown in the virtual environment and the generated haptic forces correspond to interactions of the moveable device with virtual objects or conditions in the virtual environment.

It will be appreciated by those skilled in the art, that is, by those having skill and experience in the technology areas involved in the novel systems disclosed here with haptic force feedback, that significant advantages can be achieved by such systems. For example, in certain embodiments, in order to become more proficient in performing a procedure, a person can practice the procedure, e.g., a surgical procedure, assembly procedure, etc. in a virtual environment. The presentation of a virtual environment coupled with haptic force feedback corresponding, e.g., to virtual interactions of a magnetically responsive, moveable device used in place of an actual tool, etc., can simulate performance of the actual procedure with good realism. Especially in embodiments of the systems and methods disclosed here employing one or more untethered tools or other untethered moveable devices, there is essentially no friction in the movement of the device and hence no wear due to friction. Especially in embodiments of the systems and methods disclosed here employing dual sampling rates for local control and force interaction, dynamic force feedback can be achieved with good response time, resolution and accuracy. Especially in embodiments of the systems and methods disclosed here employing Hall-effect sensors or other suitable position sensors in the stator to refine tool position, high bandwidth force control loop can be achieved, e.g., equal to or greater than 1 KHz. These and at least certain other embodiments of the systems (e.g., methods, devices etc.) disclosed here are suitable to provide advantageous convenience, economy, accuracy and/or speed of training. Innumerable other applications for the systems disclosed here will be apparent too those skilled in the art given the benefit of this disclosure.

### BRIEF DESCRIPTION OF THE DRAWINGS

FIG. 1 is a schematic perspective view of certain components of one embodiment of the virtual environment systems disclosed here with magnetic haptic feedback, employing an untethered moveable device in the nature of a surgical implement or other hand tool.

FIG. 2 is a schematic perspective view of certain components of another embodiment of the virtual environment systems disclosed here with magnetic haptic feedback, employing a magnetized tool, mobile stage and magnetic stator suitable for the system of FIG. 1.

FIG. 3 is a schematic illustration of exemplary distributed electromagnetic fields and exemplary magnetic forces generated during operation of the embodiment of FIG. 1 using a work tool or other mobile device comprising a permanent magnet.

FIG. 4 is a schematic perspective view of a stator having an exemplary electromagnetic winding array design suitable for the systems of FIGS. 1 and 2 and operative to generate the forces illustrated in FIG. 3.

FIG. 5 is a schematic illustration of control architecture for the magnetic haptic feedback system of FIG. 1.

FIG. 6 is a schematic illustration of an exemplary magnetic force generation algorithm suitable for maglev haptic interactions of FIG. 3.

FIG. 7 is a schematic illustration of an exemplary controller or computer control system and associated components of an embodiment of the haptic feedback systems disclosed here (FIG. 1 and FIG. 5).

FIG. 8 is a schematic illustration of a controller or computer control system suitable for the embodiment of FIG. 1 and FIG. 5.

The figures referred to above are not drawn necessarily to scale and should be understood to provide a representation of certain exemplary embodiments of the invention, illustrative of the principles involved. Some features depicted in the drawings have been enlarged or distorted relative to others to facilitate explanation and understanding. In some cases the same reference numbers may be used in drawings for similar or identical components and features shown in various alternative embodiments. Particular configurations, dimensions, orientations and the like for any particular embodiment will typically be determined, at least in part, by the intended application and by the environment in which it is intended to be used.

### DETAILED DESCRIPTION OF CERTAIN PREFERRED EMBODIMENTS

For purposes of convenience, the discussion below will focus primarily on certain exemplary embodiments of the virtual environment systems disclosed here, wherein the systems are operative for simulating surgery on a patient, either for training or to assist remotely in an actual operation. It should be understood, however, that the principles of operation, system details, optional and alternative features, etc. are generally applicable, at least optionally, to embodiments of the systems disclosed here that are operative for other uses, e.g., participation in virtual reality fantasy games, training for other (non-medical) procedures, etc. Given the benefit of this disclosure, it will be within the ability of those skilled in the art to apply the disclosed systems to innumerable such other uses.

As used here and in the appended claims, the term “virtual interaction” is used to mean the simulated interaction of the moveable device (or more properly of the virtual item that is represented by the moveable device in the virtual environment) with an object or a condition of the virtual system. In embodiments, for example, in which the moveable device represents a surgical scalpel, such virtual interaction could be the cutting of tissue.

The system would generate haptic feedback force corresponding to the resistance of the tissue.

As used here and in the appended claims, the term “humanly detectable” in reference to the haptic forces applied to the moveable device means having such strength and vector characteristics as would be readily noticed by an appropriate user of the system during use under ordinary or expected conditions.

As used here and in the appended claims, the term “vector characteristics” means the direction or vector of the maglev haptic force(s) generated by the system on the moveable device at a given time or over a span of time. In certain exemplary embodiments the vector characteristics may be such as to place a rotational or torsional bias on the moveable device at any point in time during use, e.g., by simultaneous or sequential actuation of different subsets of the coils to have opposite polarity from each other.

As used here and in the appended claims, the term “dynamic” means changing with time or movement of the moveable device. It can also mean not static. Thus, the term “dynamic virtual environment” means a computer-generated virtual environment that changes with time and/or with action by the user, depending on the system and the environment being simulated. The net magnetic force applied to the moveable device is dynamic in that at least from time to time during use of the system it changes continuously with time and/or movement of the moveable device, corresponding to circumstances in the virtual environment. It changes in real time, meaning with little or no perceptible time lag between the actual movement of the device (or other change of condition in the virtual environment) and the application of corresponding maglev haptic forces to the device by actuation of the appropriate subset (or all) of the coils of the stator. The virtual display is dynamic in that it changes in real time with changes in the virtual environment, with time and/or with movement of the moveable device. For example, the position (location and/or orientation) of the image or icon representing the moveable device in the virtual environment is updated continuously during movement of the device in the operating space. It should be understood that “continuously” means at a refresh rate or cycle time adequate to the particular use or application of the system and the circumstances of such use. In certain exemplary embodiments the net magnetic force and/or the display of the virtual environment (and/or other dynamic features of the system) will operate at a rate of 20 Hz, corresponding to a refresh time of 50 milliseconds. Generally, the refresh time will be between 1 nanosecond and 10 seconds, usually between 0.01 milliseconds and 1 second, e.g., between 0.1 millisecond and 0.1 second.

In accordance with certain exemplary embodiments of the systems disclosed here, an untethered device incorporating a permanent magnet is used for haptic feedback with a detector comprising an optical- or video-based sensor and a tracking algorithm to determine the position and orientation of the tool. The tracking algorithm is an algorithm through which sensory information is interpreted into a detailed tool posture and tool-tip position. In certain exemplary embodiments a tracking algorithm comprising a 3D machine vision algorithm is used to track hand or surgical instrument movements using one or more video cameras. Alternative tracking algorithms and other algorithms suitable for use by the controller in generating control signals to the actuator and display signals to the display device corresponding to the location of the tool of the system will be apparent to those skilled in the art given the benefit of this disclosure. Alternatively, such algorithms can be developed by those skilled in the art without undue experimentation, given the benefit of this disclosure. Discussion of tracking an object is found in abovementioned U.S. Pat. No. 6,704,001 to Schena et al., and the disclosure of U.S. Pat. No. 6,704,001 to Schena et al. is incorporated herein by reference in its entirety for all purposes.

In certain exemplary embodiments the moveable device incorporates at least one permanent magnet to render it magnetically responsive, e.g., a small neodymium iron boron magnet rigidly attached to the exterior or housed within the device. During use of the system, maglev force is applied to such on-board magnet by the multiple electromagnets of the stator. The force can be attractive or repulsive, depending on its polarity and vector characteristics relative to the position of the moveable device. In certain exemplary embodiments the moveable device incorporates no permanent magnet and is made of steel or other iron bearing alloy, etc. so as to be responsive to attractive maglev forces generated by the stator. In certain exemplary embodiments a degree of magnetism can be impressed in the moveable device at least temporarily by exposing it to a magnetic field generated by the stator and/or by another device, and then actuating the stator to generate maglev forces, even repulsive maglev forces to act on the device.

Control systems suitable for embodiments of the magnetic haptic feedback systems disclosed here are discussed further, below.

At least certain exemplary embodiments of the magnetic haptic feedback systems disclosed here are well suited to open surgery simulation. Especially advantageous is the use of an untethered moveable device as a scalpel or other surgical implement. Real time maglev haptic forces on a moveable device which is untethered and comprises a permanent magnet, a display of the virtual surgical environment that includes an image representing the device, and unrestricted movement in the operating space all cooperatively establish a system that provides dynamic haptic feedback for realistic simulations of tool interactions. In addition, in embodiments having a mobile stage, the operating space can be larger, even as large as a human torso for realistic operating conditions and field. Certain such embodiments are suitable, for example, for simulation of open heart surgery, etc. Certain exemplary embodiments are well suited to simulation of minimally invasive surgery.

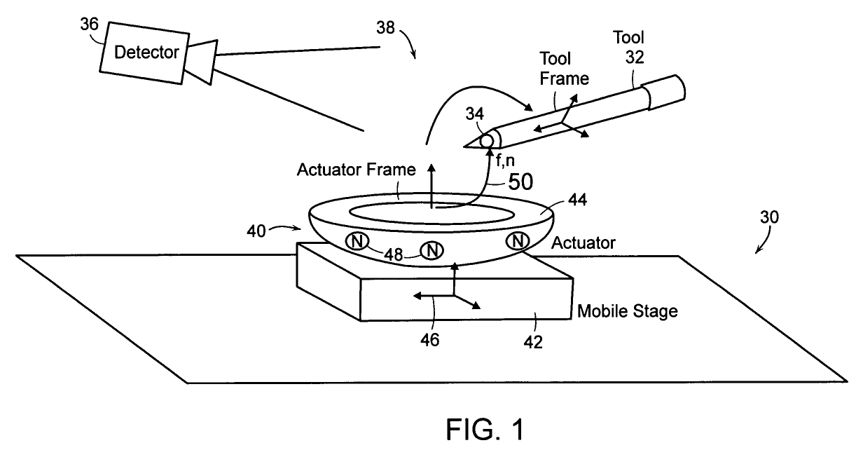

Referring now to FIG. 1, certain components of one embodiment of the haptic feedback systems disclosed here are shown schematically. The system 30 is seen to comprise a moveable device 32 comprising an untethered hand tool having a permanent magnet 34 positioned at the forward tip. Optionally, for better tracking, the forward tip can be marked or painted a suitable color or with reflective material. The system is seen to further comprise a detector 36 comprising a video camera positioned to observe and track the tool 32 in the operating space 38. The system further comprises actuator 40 comprising mobile stage 42 and stator 44. The mobile state 42 provides support for stator 44 and comprises an x-y-z table for movement of stator 44 in any combination of those three dimensions. Thus, the operating space is effectively enlarged by the mobility of the stator through actuation of the mobile stage in x-y-z space as indicated at 46. Stator 44 comprises multiple electromagnet coils 48 at spaced locations in the stator. Selective actuation of some or all of the electromagnet coils 48 generates a net magnetic force represented by line 50 to provide haptic feedback to an operator of the system holding hand tool 32.

The haptic force feedback system shown in FIG. 1 is composed of four components: 1) a moveable device in the form of an untethered magnetized tool comprising one or more permanent magnets, 2) a detector comprising vision-camera sensors or other types sensors, 3) a stator comprising multiple electromagnet coils spaced over an inside concave surface of the stator, each controlled independently to generate an electromagnetic field, and cooperatively to generate a net magnetic force on the moveable device, and 4) a high precision mobile stage to which the stator is mounted for travel within or under the operating space. The embodiment of FIG. 1 and certain other exemplary embodiments may also comprise sensors operative to detect the position of the stator (directly or indirectly, e.g., by detecting the position of a feature or component of the mobile stage having a fixed position relative to the stator). Such stator position sensors may be the same sensors used to detect the position of the moveable object or different sensors. Signals from such stator position sensors to the controller can improve stator position accuracy or resolution. Exemplary sensors suitable for detecting the position of the moveable device or the stator (here, as elsewhere in this discussion, meaning location, orientation and/or movement of the moveable device or the stator) include optical sensors such as cameras, phototransistors and photodiode sensors, optionally used with one or more painted or reflective areas on a surface of the tool. A beam of light can be emitted from an emitter/detector to such target areas and reflected back to the detector portion of the emitter detector. The position of the tool or other moveable device or the stator can be determined, e.g., by counting a number of pulses that have moved past a detector. In other embodiments, a detector can be incorporated into the moveable device (or stator), which can generate signals corresponding to the position of the moveable device (or stator) relative to a beam emitted by an emitter. Alternatively, other types of sensors can be used, such as optical encoder s, analog potentiometers, Hall-effect sensors or the like mounted in any suitable location. The tool position data and optional stator position data each alone or cooperatively can provide a high bandwidth force control feedback loop, especially, for example, at a refresh rate greater than 1 kHz.

In embodiments such as that of FIG. 1, the system's controller receives detection signals from the detector, including position measurements obtained optically, and optionally other input information, and generates corresponding control signals to the actuator to generate appropriate maglev haptic feedback forces and to move the mobile stage (and hence the stator) to keep it proximate the moveable device (i.e., within effective range of the moveable device). More specifically, the controller causes the appropriate subset of electromagnet coils (from one to all of the coils being appropriate at any given moment) to energize. The controller also generates display signals to the display device to refresh the virtual environment, including, e.g., the position of the moveable device in the virtual environment. The ability to move the stator to be moved by the actuator provides an advantageously large workspace, i.e., an advantageously large operating space for the illustrated embodiment. The controller typically comprises a computer that implements a program with which a user is interacting via the moveable device (and other peripherals, if appropriate, in certain exemplary embodiments) and which can include force feedback functionality. The software running on the computer may be of a wide variety and it will be within the ability of those skilled in the art to provide such software given the benefit of this disclosure. For example, the controller program can be a simulation, video game, Web page or browser that implements HTML or VRML instructions, scientific analysis program, virtual reality training program or application, or other application program that utilizes input of the moveable device and outputs force feedback commands to the actuator. For example, certain commercially available programs include force feedback functionality and can communicate with the force feedback interface of the controller using standard protocol/drivers such as I-Force.R™ or TouchSense.™ available from Immersion Corporation. Optionally, the display may be referred as presenting “graphical objects” or “computer objects.” These objects are not physical objects, but are logical software unit collections of data and/or procedures that may be displayed as images on a screen or other display device driven (at least partly) by the controller computer, as is well known to those skilled in the art. A displayed cursor or icon or a simulated cockpit of an aircraft, a surgical site such as a human torso, etc. each might be considered a graphical object and/or a virtual environment. The controller computer commonly includes a microprocessor, random access memory (RAM), read-only memory (ROM), input/output (I/O) electronics and device(s) (e.g., a keyboard, screen, etc.), a clock, and other suitable components. The microprocessor can be any of a variety of microprocessors available now or in the future from, e.g., Intel, Motorola, AMD, Cyrix, or other manufacturers. Such microprocessor can be a single microprocessor chip or can include multiple primary and/or co-processors, and preferably retrieves and stores instructions and other necessary data from RAM and/or ROM as is well known to those skilled in the art. The controller can receive sensor data or a sensor signals via a bus from sensors of th system. The controller can also output commands via such bus to cause force feedback for the moveable device.

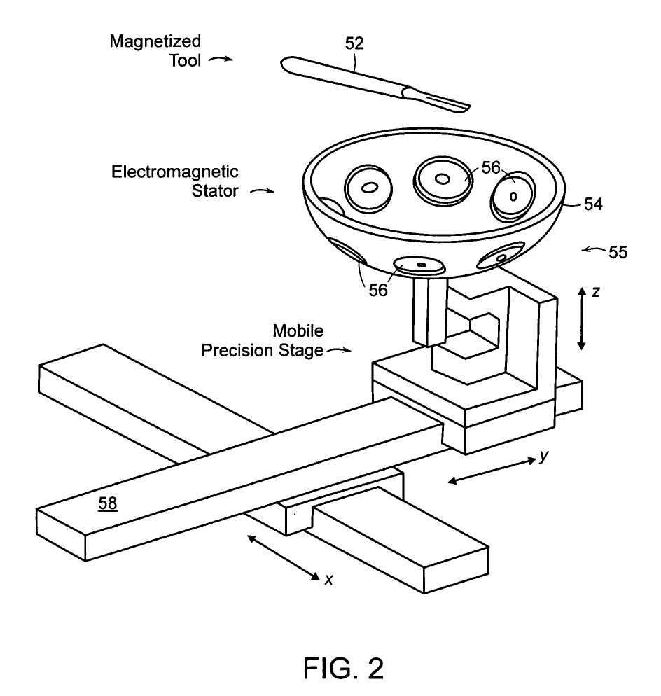

FIG. 2 schematically illustrates components in accordance with certain exemplary embodiments of the maglev haptic systems disclosed here. More specifically, a schematic model is illustrated in FIG. 2 of a magnetized tool and actuator comprising a mobile stage and electromagnetic stator suitable for use in the untethered magnetic haptic feedback system of FIG. 1. Moveable device 52 comprises a magnetized tool for hand manipulation by the person operating or using the system. The magnetically responsive, untethered device 52 optionally can correspond to a surgical tool. The stator has distributed electromagnetic field windings. More specifically, the stator 54 is seen to comprise multiple electromagnet coils 56 at spaced locations. The coils of the stator are spaced evenly on the inside concave surface of a stator body. That is, the electromagnet coils 56 are positioned roughly at the surface of a concave shape. The stator further comprises power electronic devices for current amplifiers and drivers, the selection and implementation of which will be within the ability of those skilled in the art given the benefit of this disclosure. In addition to stator 54 the actuator 55 comprises x-y-z table 58 for moving the stator in any combination of those three directions or dimensions. That is, the mobile precision stage is an x-y-z table able to move the stator in any direction within its 3D range of motion. Suitable control software for interfacing with a control computer that receives vision tracking information and provides control I/O for the mobile stage and excitation of the distributed field windings will be within the ability of those skilled in the art given the benefit of the discussion below of suitable control systems.

The mobile stage can comprise, for example, a commercially available linear motor x-y-z stage, customized as needed to the particular application. Exemplary such embodiments can provide an operating space, e.g., a virtual surgical operation space of at least about 30 cm by 30 cm by 15 cm, sufficient for a typical open surgery, with resolution of 0.05 mm or better. The mobile stage carries the stator with its electromagnet field windings, and the devices representing surgical tools will use permanent magnets. In these and other exemplary embodiments, NdFeB (Neodymium-iron-boron) magnets are suitable permanent magnets for use in the maglev haptic feedback system, e.g., NdFeB N38 permanent magnets. NdFeB is generally the strongest commonly available permanent magnet material (about 1.3 Tesla) and it is practical and cost effective for use in the disclosed systems. In certain exemplary embodiments the maglev haptic system can generate a maximum force on the mobile device in the operating space, e.g., an operating space of the dimensions stated above, of at least about 5 N, in some embodiments greater than 5 N. Additional and alternative magnets will be apparent to those skilled in the art given the benefit of this disclosure.

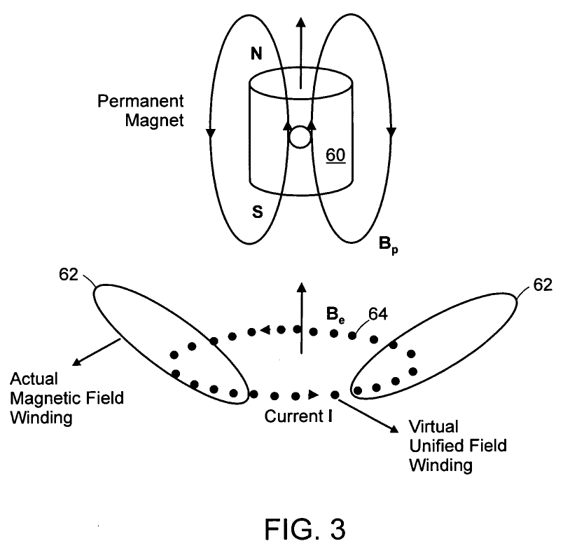

Given the benefit of this disclosure, including the following discussion of control systems for the maglev force feedback virtual environment systems disclosed here, it will be within the ability of those skilled in the art to design and implement suitable controllers for such maglev systems. In certain exemplary embodiments wherein the magnetic field interaction is between a permanent magnet and a unified electromagnetic field (see FIG. 3), the free space magnetic force generation takes the following form:
F=αBₚBₑ(I), (1)
where α is a coefficient that depends on the magnetic field configuration and properties, Bₚ and Bₑ are the magnetic field density of the magnet and electromagnetic field respectively.

FIG. 3 illustrates the principle of force generation between a permanent magnet and an electromagnetic field in at least certain exemplary embodiments of the systems disclosed here, where the desirable electromagnetic field is generated by means of a distributed winding array. Given a magnetic field projection, the spatial electromagnetic winding subset or winding firing pattern, and the energetic current level in the selected windings can be determined accordingly. Hence a desirable magnetic force feedback can be generated on the magnetized tool. Specifically, FIG. 3 shows the force generation with a permanent magnet and distributed electromagnetic fields. More specifically, the electromagnet forces on a permanent magnet 60 are generated by schematically illustrated electromagnet coils 62. The combined effect of actuating these multiple electromagnet coils is a virtual unified field winding 64. Current I and the Bₑ field are illustrated in FIG. 3 with respect to permanent magnet 60. Thus it can be appreciated that selective actuation of one or more electromagnet coils in a multi-coil array can provide haptic feedback to a magnetically responsive hand tool in accordance with well understood force equations for electromagnetic effects.

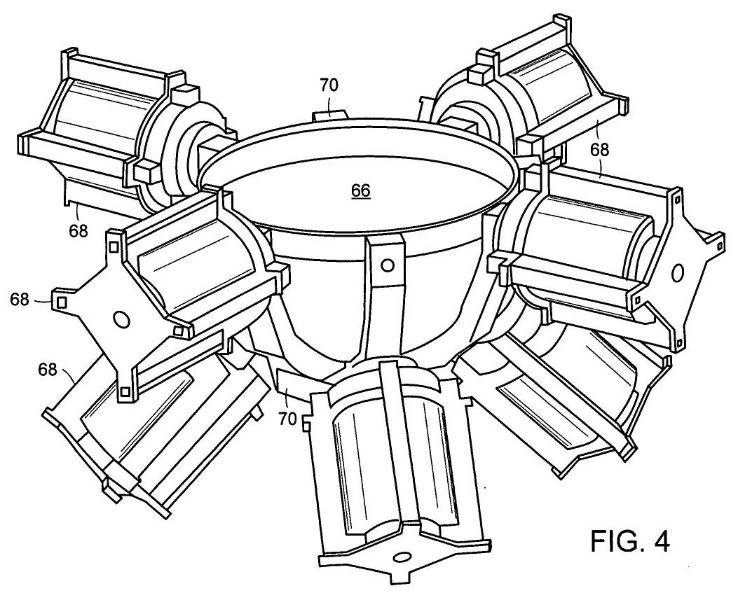

Illustrated in FIG. 4 is a design embodiment for the distributed electromagnetic winding array assembly. The winding array is to provide a continuously controlled electromagnetic field for magnetic force interaction with a magnetized tool. The embodiment shown in FIG. 4 is a hemispheric shape of shell with nine electromagnetic windings mounted on it in a set spatial distribution form. The shape of the concave shell and the way of winding distribution can be varied depending on the particular application for which the system is intended. Schematically illustrated stator 66 is seen to comprise multiple electromagnet coils 68 at spaced locations defining a concave, roughly hemispheric shape. More windings can be distributed on the concave hemispheric shell for finer spatial field distribution. However, the shape of the concave shell and the particular distribution of the windings can be varied depending on the application. Cubic shapes or other shapes, e.g., a flat plane, etc., can be applied for different applications. In the schematically illustrated stator of FIG. 4, the electromagnet coils 68 are mounted to arms of a frame 70. Numerous alternatives suitable arrangements for the electromagnet coils and for their mounting to the stator will be it will be apparent to those skilled in the art, given the benefit of this disclosure. Considering the influence of the distributed electromagnetic field winding iron core, the total force can be formulated as

$$F = α {B}_{p} {B}_{e} ( I ) - β \frac{{B}_{e}^{2}}{{μ}_{0}} , \qquad ( 2 )$$

where β is a coefficient that depends on the magnetic field properties.

It is desirable in at least certain exemplary embodiments that a 3D winding array used in a stator as described here be operative to supply sufficient controllable electromagnetic field intensity for generating a magnetic force on a magnetized surgical tool. The winding array is to be attached to a mobile stage that has dynamic tracking capability for following the tool and locating the surgical tool at the nominal position for effective force generation. Four main factors can advantageously be considered in optimal design of electromagnetic windings:
Geometric limitation
Magnetic force generation
Thermal energy dissipation
Winding mass

The size of winding is determined by the 3D winding spatial dimension, and the winding needs to provide as strong a magnetic field intensity as possible. The nominal current magnitude must satisfy the requirement of force generation yet generate a sustainable amount heat during the high-force state. The mass of the winding should be small enough that the mobile stage can respond dynamically to the motion of the surgical tool.

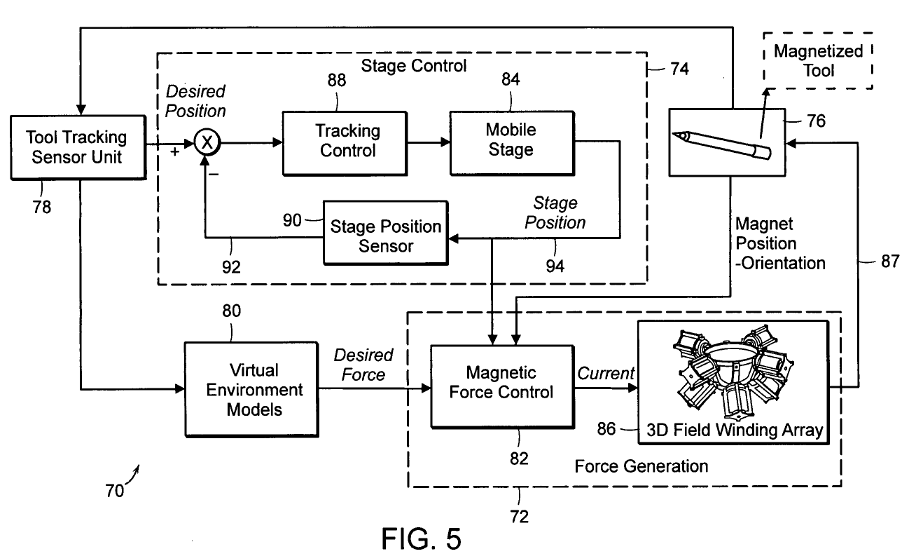

FIG. 5 shows suitable control system architecture for certain exemplary embodiments of the maglev haptic systems disclosed here, more specifically, selected functional components of a controller for a maglev haptic feedback system in accordance with the present disclosure. It can be seen that the control architecture of the embodiment of FIG. 5 comprises two modules: stage control and force generation. The desired position information is provided by means of a vision-based tool-tracking module or other alternative high bandwidth sensing device module in the system, in accordance with the principles discussed above. In an embodiment adapted to simulate a surgical field, the desired force feedback corresponding to virtual interaction of the surgical tool (moveable device) and virtual tissue of the patient, referred to here as tool-tissue interaction, is computed using the virtual environmental models such as tissue deformation models in the surgical simulation cases. The desired force vector is realized by adjusting the distribution of the spatial electromagnetic field and the excitation currents in the field windings. Tracking sensory units provide information for controlling the mobile stage, the magnetic winding array and the magnetic force feedback generation. During use, the functional components of controller 70 illustrated in FIG. 5, including force generation module 72 and stage control module 74, operate as follows. A magnetically responsive hand tool 76 is moveable within an operating space where it is detected by tool tracking sensor unit 78. Sensor unit 78 generates corresponding signals the forced generation module 72 via virtual environment models component 80 in which a desired haptic feedback force on the tools 76 is determined. A signal corresponding to such desired haptic force is generated by virtual environment models component 80 to magnetic force control module 82 together with signals from the mobile stage component 84 of stage control 74 (discussed further below) the magnetic force control model 82 determines the actuation current feed to ball or a selected subset of the 3D field winding array provided by stator 86. Stator 86 generates corresponding haptic feedback force on tool 76 as indicated by line 87. Tool tracking sensor units 78 also provides tool position signals to stage control module 74. Tracking control module 88 of stage control 74 processes signals from the sensor unit 78 which generates actuator control signals to the actuator for positioning the mobile stage (and hence the stator) of the actuator. One or more sensors 90, optionally mounted to the stator or mobile stage, generate signals corresponding to the position of the mobile stage (and stator) in a information feedback loop via line 92 for enhanced accuracy in mobile stage positioning. Also, stage position signals are sent via line 94 to magnetic force control module 82 of force generation functionality 72 for use in calculating haptic force signals to the stator 86.

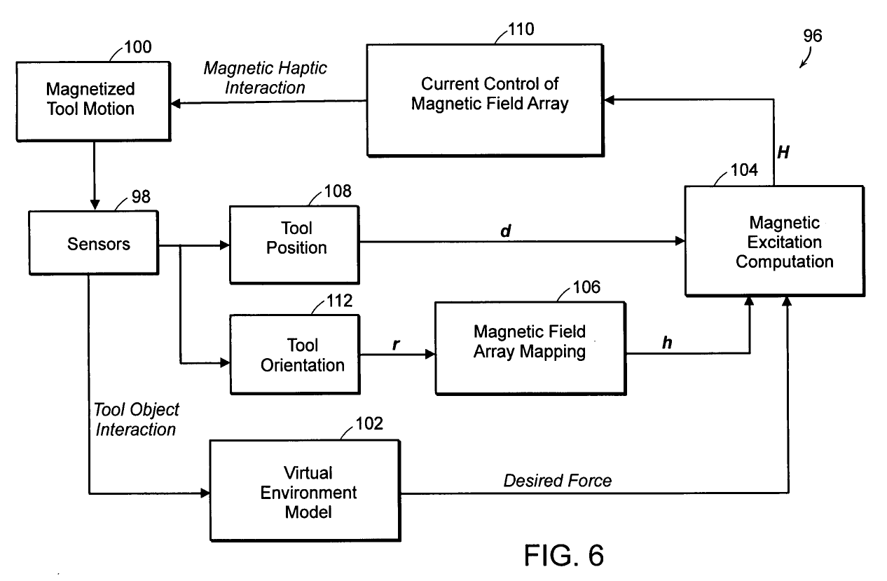

One exemplary haptic force feedback control scheme embodiment is shown in FIG. 6, more specifically, an exemplary control architecture for a magnetic haptic feedback system, such as the embodiment of FIG. 1. The force feedback loop contemplates the position (location and orientation) of the moveable tool, alternatively referred to as its “pose” (position (here meaning location) and orientation) with respect to the actuator. In certain exemplary embodiments the tool has six degrees of freedom, represented through relative orientation and relative position. Control architecture 96 is seen to comprise sensors 98, such as cameras or other video image capture sensors, Hall Effect sensors etc. for determining motion of a magnetically responsive tool 100 in an operating space. Virtual interaction of the actual tool and the virtual environment is determined by module 102 based at least on signals from sensors 98 regarding the position or change of position of the magnetized tool. The corresponding desired haptic feedback force is determined by magnetic excitation computation module 104 based at least in part on signals from virtual environment model 102 regarding the desired force representing the virtual interaction on the signals from magnetic field array mapping module 106 and on the tool position signals from tool position module 108 which, in turn, processes signals from sensors 98 regarding motion of the tool. Haptic force signals determined by module 104 determine the magnetic haptic interaction between the magnetized tool and the stator, via control of the actuation current fed to the magnetic field array based on module 110. In addition to tool position module 108, tool orientation module 112 receives signals from the sensors 98, especially for use in systems employing an untethered magnetically responsive device as the moveable device, and especially in systems wherein the moveable device comprises a second permanent magnet mounted perpendicular to (or at some other appropriate angle to) the primary permanent magnet of the device.

The magnetic force interaction between a permanent magnet and an aligned equivalent electromagnetic coil is a function of the magnetic field strength of the permanent magnet, the current value in the coil, and the distance between these two components in free space. For real world multi-dimensional problems the accurate measurement of the orientation of permanent magnetic field will be provided with a set of sensory detectors. The permanent magnet field can be chosen in the direction of a tool axis by design. Therefore, within this control scheme embodiment we choose to control the distributed electromagnetic field winding array according to the tool motion so that the controlled electromagnetic field of the stator can be aligned in the same direction, a relative field direction or opposite direction of the surgical tool axis. Six degrees of freedom force feedback control can be generated by means of this control mechanism. A nonlinear magnetic field mapping module determines the excitation spatial pattern and current distribution profile according to the requirement of magnetic field projection. Virtual environment model, magnetic field array mapping and tool tracking sensors provide information in magnetic excitation control.

With the above engineering assumptions, we can formulate the magnetic force interaction as follows,
F=G(r,H,d) (3)
where r indicates the permanent magnetic field direction, which is parallel to the vector of permanent magnetic field flux density B, namely B=Br, H is the magnetic field strength vector of the stator, and d is the position vector of the tool tip with respect to the center of the stator.

In the above case, the above function (i.e. Equation (3)) can be expressed in a simpler scalar form when both r and H are aligned in the same direction or opposite direction. FIG. 6 shows such an engineering control scheme embodiment. Various alternative embodiments will be apparent to those skilled in the art given the benefit of this disclosure. The accurate electromagnetic field array control and alignment can be realized by means of experimental data calibration of the system behaviors and appropriate data acquisition techniques. With measured tool position and orientation, the field information of the permanent magnet can be computed. By means of selecting or activating the corresponding electromagnetic field array components the stator field can be aligned in the same (or opposite) direction of the permanent magnet. Then the interaction force can be computed in a simpler form as described above.

There are many other alternative control approaches that can be applied in magnetic force generation control. Control approaches such as Jacobian method, a typical robotic manipulator control method that based on linear perturbation theory can be used as well.

Other methods such as nonlinear pattern recognition and system identification methods can be applied. The description below is another control embodiment for the magnetic haptic system control.

In certain exemplary embodiments the tool has six degrees of freedom, represented through relative orientation R and relative position \vec{p}. The actuator has N electromagnets, and an N-length vector I represents the N current levels. With this, the force and moment on the tool can be represented through a multidimensional function G(·,·,·) as follows:

$$F = [ \begin{matrix}\vec{f} \\ \vec{n}\end{matrix} ] = G ( R , \vec{p} , I ) . \qquad ( 4 )$$

The function G is smooth, and for any set of values R, \vec{p}, and I₀, this equation can be linearized about I₀ by defining a Jacobian matrix J that can be used to approximate the force and moment as a function of I=I₀+ΔI for small ΔI as follows:
F(R,\vec{p},I)=G(R,\vec{p}I₀)+J(R,\vec{p},I₀)ΔI. (5)

For any tool pose (R and \vec{p}) and electromagnet currents I₀, the currents closest to I₀ that best approximate a desired force F_{d} can be calculated through
I=I₀+J^{#}(F_{d}−G). (6)
where J^{#} is a weighted pseudoinverse of J that 1) minimizes a quadratic function of the current changes ΔI when underconstrained or 2) minimizes a measure of the error E=F−F_{d} when overconstrained. Electromagnetic current cannot change instantaneously, and minimizing a measure of the change improves performance. In the other case—when the exact value of F_{d} is not achievable—minimizing the error gives the most realistic tactile feel. This approach works with any number of electromagnets and any number of fixed magnets on the tool. It can be used iteratively when a large change in I is needed.

The advantages of the described magnetic haptic force feedback system are the following: 1) direct force control by means of electromagnetic field control; 2) high force fidelity in force control because of no mechanical coupling or linkages involved; 3) high force control resolution since the force is proportional to the magnetic field current; 4) no backlash or friction problem like the regular mechanical coupled haptic systems; 5) robust and reliable because of no indirect force transmission required in the system; 6) large work space with high motion resolution for tool-object interactions.

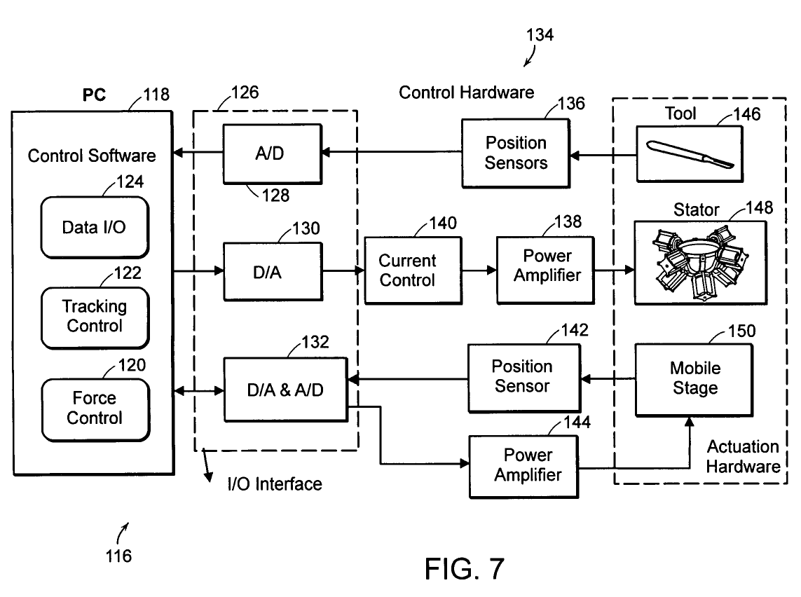

An exemplary controller or computer control system and associated components of one embodiment of the systems and methods disclosed here is schematically illustrated in FIG. 7. Specifically, controller 116 is seen to comprise control software loaded on an IBM compatible PC 118. Such control software includes force control module 120, tracking control module 122 and data I/O module 124. It will be recognized by those skilled in the art, given the benefit of this disclosure, that additional or alternative modules may be included in the control software. A data signal interface 126 is seen to comprise analog to digital (A/D) component 128, digital to analog (D/A) component 130 and D/A and A/D component 132. Control hardware 134 is seen to include position sensors 136, power amplifier 138, current controller 140, mobile stage position sensor 142 and additional power amplifier 144. The control hardware is seen to provide an interface between other components of the maglev haptic system and the control software. More specifically, position sensors 136 provide signals to A/D component 128 corresponding to the position or movement of tool 146. Current control component 140 and power amplifier 138 provide actuation energy to stator 148. Power amplifier 144 provides actuation energy to mobile stage 150 of the actuator for positioning the stator during use of the system. Movement of the mobile stage is controlled, at least in part, based on signals from position sensor 142 to the force control module 120 of the control software, based on the position of the mobile stage.

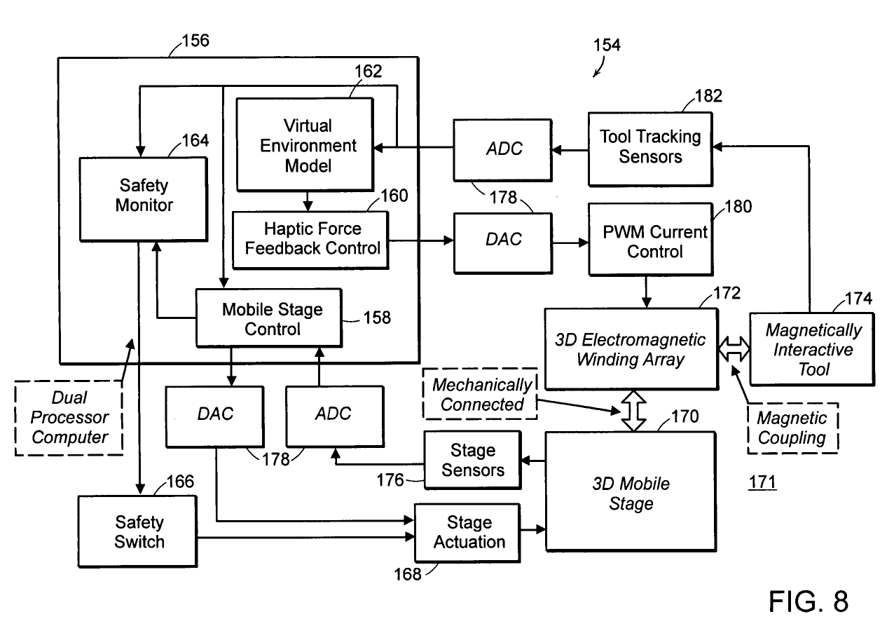

A computer control suitable for at least certain exemplary embodiments of the systems and methods disclosed here is illustrated in FIG. 8. The control of FIG. 8 is suitable for example, for a tissue deformation model in an embodiment of the disclosed systems and methods adapted for simulating a surgical procedure. Within this computer control system, a dual microprocessor is used for handling virtual environment model and visualization display etc. with partial of the computational power while the primary computation is taken in haptic force feedback control, mobile stage control and haptic system safety monitoring. There are mainly three hardware modules: electromagnetic winding array, magnetized tool, and a mobile stage. Tracking sensors are used to capture the tool position and posture, and stage sensors are for tracking the mobile stage and control. There are power amplifiers for the electromagnetic winding array and mobile stage, specifically, the PWM current control and stage actuation, respectively, in FIG. 8. ADC and DAC components are responsible for the analog-to-digital and digital-to-analog signal conversion and the computer signal interface. A safety switch is particularly for necessary safety interaction while the haptic system is engaged in applications. Three computer software modules are mainly implemented in the dual-processor computer: virtual environment models, haptic force feedback control, and system safety monitor. Other computer control embodiments can be selected according to the system applications, such as multiple computers or networked or wireless-networked control systems etc.

The computer control system structure of FIG. 8 is suitable for certain exemplary embodiments of the maglev haptic systems and methods disclosed here. It includes a dual microprocessor, computer interface devices, control software modules and the key maglev haptic system components. The system components are listed as follows:
DAC and ADC
PWM current control
Tool tracking sensors
3D electromagnetic winding array assembly
Magnetized tool
3D mobile stage with control system and stage tacking sensing
Safety switch module
Dual microprocessor computer
High speed video card (VR environment display)
Software for mobile stage tracking control, haptic feedback control and safety monitoring

Controller 154 of FIG. 8 comprises a computer system 156 suitable for controlling, for example, an embodiment in accordance with FIG. 1. Computer system 156 is a dual processor computer with functionality comprising at least mobile stage control 158, haptic force feedback control 160, virtual environment module 162 and safety monitor module 164. Safety monitor module 164 is seen to control safety switch 166 which can interrupt stage actuation 168. Stage actuation 168 controls movement of 3D mobile stage 170 of an actuator 171 of the system and, hence, the position of a stator 172 comprising a 3D electromagnetic winding array. Consistent with the discussion above, the actuation of the stator 172 provides haptic force on a magnetically responsive tool 174. Thus, the stator 172 is mechanically connected to mobile stage 170 and is magnetically coupled to tool 174. The operating space in which magnetically interactive tool 174 can be used is larger than it would be without mobile stage 170, because the stator can be moved to follow the tool. Mobile stage 170 is referred to as a 3D mobile stage because it is operative to move stator 172 in 3 dimensional space. Information feedback loop regarding the position of the mobile stage 170 and, hence, of stator 172 relative to the operating space is provided by stage sensors 176. Signals to and from computer 156, including for example signals from stage sensors 176 corresponding to the position of mobile stage 170, are communicated to and from computer 156 via suitable analog to digital or digital to analog components 178. Haptic force feedback control 160 provides control signals for powering the electromagnet coils of stator 172 through PWM current control 180. Signals generated by the system detector 182 comprising tool tracking sensors, e.g., cameras, Hall Effect sensors etc., are feed to virtual environment model 162 of control computer 156. In turn, virtual environment model 162 provides haptic feedback signals to haptic force feedback control 160.

Maglev haptic systems in accordance with this disclosure can generally be applied in any areas where conventional haptic devices have been used. At least certain exemplary embodiments of the systems disclosed here employ an open framework, and thus can be integrated into other, global systems.

Especially those embodiments of the maglev haptic feedback systems disclosed here which employ an untethered moveable device are readily adapted to virtual open surgery simulations as well as other medical training simulations and other areas. These systems are advantageous, for example, in comparison with prior systems, such as joystick-like haptic input units, the maglev haptic systems disclosed here have no physical constraints on the tool, since it is untethered. Also, they are concept based systems. That is, they can be designed and implemented as a self sufficient system instead of as a component of another system. Also, certain exemplary embodiments provide a large working-space, especially those comprising a mobile stage to move the stator. In comparison with certain other conventional haptic devices, at least certain exemplary embodiments of the systems disclosed here provide haptic feedback force to an untethered hand tool, rather than to a tool which is mechanically mounted or coordinated to a mechanical framework that defines the haptic interface within mechanical constraints of the mounting bracket, etc. Such systems of the present disclosure can provide a more natural interface for surgical trainees and other users of the systems.

Certain exemplary embodiments of the systems disclosed here can provide fast tool tracking by the xyz stage with resolution of 0.05mm and speeds of up to 20 cm/sec. In certain exemplary embodiments untethered tool tracking is performed by sensors such as RF sensors, optical positioning sensors and visual image sensors; encoders can also be used to register the spatial position information. One or more visual sensors can be used with good performance. Additional tools can be included for specific tasks, with selected tracking feedback sensing the tools individually. In certain exemplary embodiments wide working space is accomplished via a mobile tracking stage, as discussed above. The untethered haptic tool can move in an advantageously wide working space, such as X-Y-Z dimensions of 30 cm by 30 cm by 15 cm, respectively. Certain exemplary embodiments provide high resolution of motion and force sense, e.g., as good as micron level resolution, with resolution depending generally to some extent on the tracking sensors. In certain exemplary embodiments dynamic force feedback is provided, optionally with dual sampling rates for local control and force interaction. In certain exemplary embodiments exchangeable tools are provided. Such tools, for example, can closely simulate the actual tools used in real surgery, and can be exchanged without resetting the system.

In using certain exemplary embodiments of the systems and methods disclosed here, a user manipulatable object, the aforesaid moveable device, e.g., an untethered mock-up of a hand tool, is grasped by the user and moved in the operating space. It will be appreciated that a great number of other types of user objects can be used with the methods and systems disclosed here. In fact, the present invention can be used with any mechanical object where it is desirable to provide a human-computer interface with three to six degrees of freedom. Such objects may include a stylus, mouse, steering wheel, gamepad, remote control, sphere, trackball, or other grips, finger pad or receptacle, surgical tool, catheter, hypodermic needle, wire, fiber optic bundle, screw driver, assembly component, etc.

The systems disclosed here can provide flexibility in the degrees of freedom of the hand tool or other moveable device, e.g., 3 to 6 DOF, depending on the requirements of a particular application. This flexible in structure and assembly is advantageous and can enable effective design and operation. As noted above, certain exemplary embodiments of the systems disclosed here provide high-fidelity resolution of motion and force. Force resolution can be as high as, e.g., ±0.01 N, especially with direct current drive. The force exerted by the stator on the moveable device at the outermost locations of the operating space (i.e., at the locations furthest from the stator) can be higher than 1 N, e.g., up to five Newtons (5 N) in certain exemplary embodiments and up to ten Newtons (10 N) or more in certain other exemplary embodiments. Other embodiments of the systems and methods disclosed here require lower maglev forces. In certain exemplary embodiments the actuator is able to generate a maglev force on the moveable device at the outermost locations in the operating space of not more than 0.001 N. In certain exemplary embodiments the actuator is able to generate a maglev force on the moveable device at the outermost locations in the operating space of more than 0.001 N. In certain exemplary embodiments the actuator is able to generate a maglev force on the moveable device at the outermost locations in the operating space of not more than 0.01 N. In certain exemplary embodiments the actuator is able to generate a maglev force on the moveable device at the outermost locations in the operating space of more than 0.01 N. In certain exemplary embodiments the actuator is able to generate a maglev force on the moveable device at the outermost locations in the operating space of not more than 0.1 N. In certain exemplary embodiments the actuator is able to generate a maglev force on the moveable device at the outermost locations in the operating space of more than 0.1 N. In certain exemplary embodiments the actuator is able to generate a maglev force on the moveable device at the outermost locations in the operating space of not more than 1.0 N. As stated above, in certain exemplary embodiments the actuator is able to generate a maglev force on the moveable device at the outermost locations in the operating space of more than 1.0 N. In at least certain embodiments employing an untethered moveable device, the force feedback system, having no intermediate moving parts, has little or no friction, such that wear is reduced and haptic force effect is increased. Certain exemplary embodiments provide “high bandwidth,” that is, the force feedback system in such embodiments, being magnetic, has zero or only minor inertia in the entire workspace.

Various exemplary techniques and embodiments for features, components and elements of the systems and methods disclosed here are described below. Alternative and additional techniques and embodiments will be apparent to those skilled in the art given the benefit of this disclosure.

An exemplary tracker, that is, a subsystem for visually tracking a moveable device, such as a tool or tool model, in an operating space is shown in diagram 1, below, employing spatial estimate algorithms, and time varying or temporal, components.

[image]

The tool-tracking system is composed of a preprocessor, a tool-model database, and a list of prioritized trackers. The system is configured using XML. Temporal processing combines spatial information across multiple time points to improve assessment of tool type, tool pose, and geometry. A top-level spatial tracker (or tracker-identifier unit as shown in Diagram 1) is shown in Diagram 2.

[image]

Providing type, orientation, and articulation as input to the temporal algorithms allows tools to be robustly tracked in position, including both location and orientation. In certain known tracking algorithms, point targets are assumed with the unknown type, orientation, and articulation bundled into the noise model. In certain exemplary embodiments the tool is reliably recreated in a virtual scene exactly how it is positioned and oriented. In certain exemplary embodiments adapted for surgical training, the relationship between orientation of the tool and tissue in the virtual environment can be included.

In certain exemplary embodiments for temporal processing, data is organized into measurements, tracks, clusters, and hypotheses. A measurement is a single type, pose, and geometry description corresponding to a region in the image. A tool-placement hypothesis is assessed using AND and OR conditions, and measurements are organized and processed according to these relationships.

Of existing, proven temporal processing algorithms, Multiple Hypothesis Tracking (MHT) provides accurate results through, among other properties, its support for the initiation of tracks. It is a conceptually complete model that allows a tradeoff between computational time and accuracy. In certain exemplary embodiments adapted for surgical training, when multiple tools are present, measurements will potentially be connected in an exponentially large number of ways to form tracks and hypotheses. A practical implementation may not support this exponential growth, and shortcuts will have to be made. Realistic MHT algorithms developed over the years have handled the complexity using a number of different approaches and data structures, such as trees (D. B. Reid, “An Algorithm for Tracking Multiple Targets,” IEEE Transactions on Automatic Control, AC-24(6), pp 843-854, December 1979, the entire disclosure of which is incorporated herein for all purposes) and filtered lists of tracks (S. S. Blackman, Multiple-Target Tracking with Radar Applications, Artech House, 1986, the entire disclosure of which is incorporated herein for all purposes). These techniques eliminate unlikely data associations early and reduce complexity. Processing time and accuracy can be controlled through the selection of track capacity.

There are two broad classes of MHT implementations, hypothesis centered and track centered. In certain hypothesis-centric approaches, hypotheses are scored and hypothesis scores propagated. Track scores are calculated from existing hypotheses. Track-centric algorithms, such as those proposed by (Kurien T. Kurien, “Issues in the Design of Practical Multitarget Tracking Algorithms,” Multitarget-Multisensor Tracking: Advanced Applications, Y. Bar-Shalom Editor, Artech House, 1990, the entire disclosure of which is incorporated herein for all purposes), score tracks and calculate hypothesis scores from the track scores. To support flexibility in the design, certain exemplary embodiments can be implemented storing hypotheses in a database. Storage for a number of other MHT-related data can make the tracker configurable in certain exemplary embodiments.

Certain exemplary embodiments, though recursive, use database structures throughout for measurements, tracks, hypotheses, and related information. Each database can be configured to preserve data for any number of scans (a scan being a single timestep) to allow flexibility in how the algorithms are applied.

The temporal module shown in Diagram 2 can use four components, as illustrated in Diagram 3. The first component is the spatial pruning module, which eliminates low-probability components of the hypotheses provided by the spatial processing module. The second component, initial track maintenance, uses the measurements provided by the input spatial hypotheses to initialize tracks. The hypothesis module forms hypotheses and assesses compatibility among tracks. Finally, the remaining tracks are scored using the hypothesis information.

[image]

For special pruning, the spatial processor generates multiple spatial hypotheses from the input imagery and provide these hypotheses to the temporal processor. This is the spatial input labeled in Diagram 3, above. The temporal processor treats the targets postulated from each spatial hypothesis as a separate measurement. In order to reduce the number of hypotheses, unlikely candidates are removed at the earliest stage. This is the purpose of the spatial pruning module.

Spatial assessments allow for AND and OR relations between the spatial hypothesis. The OR options are eliminated using track information. So, for instance, in Diagram 4, below, three possibilities describing a region in the image will be reduced to a single option using information specific to temporal processing, such as knowledge that a high-probability track already has a target identified at that location or knowledge that available memory limits the input data size.

[image]

Thus, the spatial pruning module reduces the size of the input hypotheses by simple comparison the spatial input data with track data. For the remaining modules in Diagram 3, several tracker-state databases are constructed. Eight databases are used, one each for measurements, observations, measurement compatibility, tracks, filter state, track compatibility, clusters, and hypotheses. All the databases inherit from a common base class that maintains a 2D tensor of data objects for any time duration. There will be no computational cost associated with storage for longer times—only space (e.g., RAM) costs. The measurement and track databases may be long lived compared to the others. In each tensor of values, the columns will represent time steps and the rows value IDs. Diagram 5 illustrates the role these databases play and how they interact with the temporal modules.

[image]

Thus, eight databases are used to represent information in the temporal processing module. Each database maintains information for a configurable length of time. The measurement and track databases may be especially long lived. These databases support flexibility—different temporal implementations may use different subsets of these databases.

Certain objects in the databases, e.g., certain C++ objects, store information, rather than provide functionality. Processing capability is implemented in classes outside the databases. Processing data using objects associated with the target type in the target—model database allows the databases to be homogeneous for memory efficiency, while allowing flexibility through polymorphism for processing. (Polymorphism will allow Kalman Filtering track-propagation for one model, for example, and α-β for another.)

The databases are implemented as vectors of vectors—a two-dimensional data structure. Each element in the data structure is identified by a 32-bit scan ID (i.e., time tag) and a 32-bit entry ID within that scan. This data structure is illustrated in Diagram 6, below, with exemplary scan and entry IDs shown for purposes of illustration.

[image]

Thus in the illustrated common database structure, entries are organized first by scan ID (time tag), then by entry ID within that scan. Both are 32-bit values, giving each entry a unique 64-bit address. For each scan, the number of entries can be less, but not more, than the allocated size for the scan. A current pointer cycles through the horizontal axis, with the new data below it overwriting old data. With this structure, there is no processing cost associated with longer time durations.

Any entry can be accessed in constant time with scan and measurement IDs. The array represents a circular buffer in the scan dimension, allowing a history of measurements to be retained for a length of time proportional to the number of columns in the array. The database is robust enough in at least certain exemplary embodiments to handle missing and irregular timesteps as long as the timestep value is monotonically increasing in time.

It can also backfill entries in reserved time slots. The maximum time represented by the buffer is a function of the frame rate and buffer size. For example, if the tracking frequency is 50 Hz, then the buffer size would have to be 50 to hold one second of data.

Regarding feedback loop design for embodiments of the systems and methods disclosed here, tracker output data to the spatial processor to improve tracker performance. The top-level tracker-identifier system shown in Diagram 2 shows the feedback path from the temporal output back to the spatial processor. The spatial pruning module differs from the feedback loop described here in that the feedback is fed into the spatial processor before the RTPG module whereas in the pruner the feedback occurs internal to the tracker.

An exemplary spatial processor suitable for at least certain exemplary embodiments of the systems and methods disclosed here consists of three stages as shown in Diagram 7, below: An image segmentation stage, an Initial Type Pose Geometry (ITPG) processor, and a Refined Type, Pose, Geometry Processor (RTPG). Temporal processor data can be fed back to the RTPG processor, for example.

[image]

Thus, Diagram 7 illustrates the three stages of the spatial processor and the feedback from the temporal processor. The data passed into the RTPG processor consists of a set of weighted spatial hypotheses. The configuration of these standard spatial hypotheses is illustrated in Diagram 8.

[image]

Thus, in Diagram 8 each standard spatial hypothesis contains an assumed number of targets (which are AND'ed together). Associated with each target is a prioritized set of assumed states (which are OR'ed). In the above figure, the spatial processor hypothesizes that the field image could be two scalpels (left), a forceps (middle), or nothing (right). Each of these hypotheses is accompanied by a score. In this case, it would be expected that the highest score is associated with the scalpel hypothesis. The spatial hypotheses are of type EcProbabilisticSpatialHypothesis. Each hypothesis contains an EcXmlReal m_Score variable indicating the score of the hypothesis. The higher the score the more confident the ITPG module is of the prediction. Before the refinement stage, the RTPG module will take the top N hypotheses for refinement; where N is a userdefined parameter. To introduce feedback, the top N tracker outputs (also represented as EcProbabilisticSpatialHypothesis objects) are propagated forward by a timestep, and added to the collection of hypotheses passed in by the ITPG. This combined set of hypotheses is then ranked, and the N top is selected by the RTPG for refinement. This process of temporal processor feedback is illustrated in Diagram 9.

[image]

Thus, the estimated state is propagated forward through the filter and added to the hypotheses collection generated by the ITPG processor. The N best are then chosen for refinement. The state z(k) is the target collection state at timestep k.

Regarding display of a virtual environment, transparent objects are commonly seen in the real world, e.g., in surgery, such as certain tissues and fluids. To visualize transparent objects in a computer-generated synthetic or virtual world, objects can be rendered in a certain order with their color blended, to achieve the visual effect of transparency. The surface properties of an object are usually represented in red, green and blue (RGB) for ambient, diffuse and specular reflection. For rendering transparency, an alpha term is added and the color is represented in RGBA. A very opaque surface would have an alpha value close to one, while an alpha value of zero indicates a totally transparent surface.

To render a scene with transparent or semi-transparent objects, the opaque objects in the scene can be rendered first. The transparent objects are rendered later with the new color blended with the color already in the scene. The alpha value is used as a weighting factor to determine how the colors are blended. Assuming that the current color in the scene for a particular pixel is (r_{d}, g_{d}, b_{d}, a_{d}), the incoming (source) color for this pixel is (rₛ, gₛ, bₛ, aₛ), a suitable way of blending the colors is
(1−aₛ)(r_{d}, g_{d}, b_{d}, a_{d})+aₛ(rₛ, gₛ, bₛ, aₛ)

When as equals one, the current color is replaced by the incoming color. When as is between 0 and 1, some of the old color can be seen.

This blending technique can also be combined with texture mapping. Texture mapping is a method to glue an image to an object in a rendered scene. It adds visual detail to the object without increasing the complexity of the geometry. A texture image is typically represented by a rectangular array of pixels; each has values of red, green and blue (referred to as R, G and B channels). Transparency can be added to a texture image by adding an alpha channel. Each pixel of such image is usually stored in 32 bits with 8 bits per channel. The texture color is first blended with the object it is attached to, and then blended with the color already in the scene. The blending can be as simple as using the texture color to replace the object surface color, or a formula similar to (1) can be used. Compared with specifying the transparency on the object's surface property, using the alpha channel on the texture image gives the flexibility of setting the transparency at a much more detailed level.

Regarding exemplary moveable devices suitable for use in the systems and methods disclosed here, an elongated tool with one permanent magnet aligned in the tool axis allows force feedback in three axes X-Y-Z and torques in X-Y axes. An additional magnet attached perpendicular to the tool axis allows a six DOF force feedback system with the distributed electromagnetic field array stator as described above.

Regarding exemplary stators suitable for use in the systems and methods disclosed here, copper magnetic wires can be used for the electromagnetic field windings, e.g., copper magnetic wire NE12 with Polyurethane or Polyvinyl Formal film insulation from New England Electric Wire Corp. (New Hampshire), which for at least certain applications has good flexibility in assembly, good electric conductivity, reliable electric insulation with thin layer dielectrical polymer coatings, and satisfactory quality and cost. Alternative suitable wires and insulation for the field windings are commercially available and will be apparent to those skilled in the art given the benefit of this disclosure. An exemplary cylinder electromagnetic field winding configuration is shown schematically in Diagram 10, using wire NE12 (total length 16.071′ in one winding component). This provides resistance of R=25.52 mΩ. By selecting a nominal field current value of 10 A, the rated nominal power consumption/dissipation requirement is 2.552 W.

[image]

Further regarding the stator of the actuator, for a six DOF (or five DOF) maglev haptic force feedback system in accordance with the present disclosure, a desirable electromagnetic field control requires a smooth total field vector assignment associated with the orientation of the magnetized tool. A distributed stator assembly designed with nine electromagnetic field winding components, which are installed at nine unique locations of hemispheric frame shown in Diagram 11 will provide an effective magnetic field control capability. A top view of the distribution of electromagnetic field winding components is given in Diagram 12. As discussed above, FIG. 4 shows a schematic perspective view of an exemplary stator assembly.

[image]

In certain exemplary embodiments adapted for simulation of surgery on a human patient or an animal, e.g., for training or remote surgery techniques, a “Radius of Influence” tissue deformation model can be used. The “radius of influence” model is sufficient for a simplified simulation prototype where the user can press (in a virtual sense) on an organ in the virtual environment and see the surface deflect on the display screen or other display being employed in the system. Also, haptics display hardware can be used to calculate a reaction force. This method is good in terms of simplicity and low computational overhead (e.g., <1 ms processor time in certain exemplary embodiments). The “radius of influence” model can be implemented, in the following steps:

Pre-computation to facilitate steps below

Detecting initial collision of the tool with the organ

Calculating reaction force

Calculating visual displacements of the nodes on the organ surface near the tool tip

Detecting continuing collision of the tool with the organ, using connectivity.

The steps of an exemplary pre-computation procedure suitable for at least certain exemplary embodiments of the systems and methods disclosed here adapted for surgical simulation, include:
1) Load/create the data for each object in the scene. The redundant information prepared in this representation speeds haptic rendering. The data structure is outlined in Diagram 13, below, and the object data includes the following primitives:
a) Vertex coordinates in the inertial frame
b) Connectivity information that lays out the polygon
c) Lines in the inertial frame that are the edges of polygons
d) List of neighboring primitives
e) Normal vectors in the inertial frame for each primitive

[image]

Thus, regarding connectivity information for primitives, the polyhedron representing the object is composed of three primitives: vertex, line, and polygon. Each of these primitives is associated with a normal vector and a list of its neighbors.
2) Partition the polygons in each object into a hierarchical Bounding Box (BB) tree (BBt) so that the boxes at the bottom of the tree each contain a single polygon. Exemplary suitable algorithms for creation of a bounding box tree are given in Wade, B., Binary Space Partitioning Trees FAQ. 1995, Cornell, the entire disclosure of which is hereby incorporated by reference for all purposes, and related pseudocode is available, e.g., online at Kim, H., D. W. Rattner, and M. A. Srinivasan, The Role of Simulation Fidelity in Laparoscopic Surgical Training, 6th International Medical Image Computing & Computer Assisted Intervention (MICCAI) Conference, 2003, Montreal, Canada: Springer-Verlag, the entire disclosure of which is hereby incorporated by reference for all purposes.

To detect initial (virtual) collision of the tool with an organ, the following steps can be followed:
1) In the inertial frame, subtract the coordinates of the tool tip, called the Haptic Interface Point (HIP) at the last time step HIP-1 from the current coordinates HIP0, to create a line segment.
2) Test this line segment for intersection with the bounding boxes of objects in the scene. If collision is detected, descend the BB tree. At each level, if there is no collision, stop, otherwise continue descending.
3) If the bottom of the tree is reached, test for intersection of the line segment with the polygon. If there is an intersection, set the polygon as the contacted geometric primitive.

In calculating reaction force (see, e.g., Gottschalk, S., M. Lin, and D. Manocha, OBB-Tree: A hierarchical Structure for Rapid Interference Detection, SIGGRAPH, 1996, ACM, the entire disclosure of which is hereby incorporated by reference for all purposes) the point on the intersected polygon closest to the HIP is defined to be the Ideal Haptic Interface Point (IHIP). It stays on the surface of the model, whereas HIP penetrates below the surface. A vector is defined from IHIP to HIP, and penetration depth d is the length of this vector. Reaction force to be rendered through the haptic interface is calculated as F=−kd and is directed along the penetrating line segment. Higher order terms or piecewise linear terms may be added to approximate nonlinear force response of the tissue.

The following approach is suitable for use in at least certain exemplary embodiments of the methods and systems disclosed here to calculate visual displacements of the nodes on a virtual organ surface near the tool tip.
1) Use the list of the polygon's neighboring primitives to find nodes lying within the radius of influence.
2) As each neighboring node is found, displace it in the direction of the penetration vector by a magnitude that tends toward zero for more distant nodes. The magnitude of the translation can be determined by a second degree polynomial that has been shown to fit empirical data well. See, e.g., Srinivasan, M. A., Surface deflection of primate fingertip under line load. Journal of Biomenchanics, 1989, 22(4): p. 343-349, the entire disclosure of which is hereby incorporated by reference for all purposes. The form of the polynomial is straightforward. If, for example, no linear deformation is assumed (a₁=0), then the deformation function takes the following form:
   Depth=aₒ+a₂R_{d}²
   where a₀=AP, and a₂=−AP/Rᵢ² . The vector AP is constructed from the coordinates of the instrument to the contact point. Rᵢ=Radius of influence, R₂=radius of distance.

The radial distance is the distance of each neighboring vertex within the radius of the influence to the collision point. Diagram 14 shows a scenario where the “radius of influence” approach is applied.

[image]

In detecting continuing collision of the tool with the organ, using connectivity, it is advantageous in at least certain exemplary embodiments to check whether the dot product of the penetration vector and the polygon surface normal remains negative, indicating that the tool still penetrates the object. If not, resume process 2 (detecting initial collision of the tool with the organ). If the HIP is still inside penetrating the object, a “Neighborhood Watch” algorithm can be used to determine the nearest intersected surface polygon. The pseudocode for Neighborhood Watch is available in section 4.3 of C-H Ho's PhD Thesis: Ho, C.-H., Computer Haptics: Rendering Techniques for Force-Feedback in Virtual Environments, PhD Thesis, MIT Research Laboratory of Electronics (Cambridge, Mass.) p. 127 (2000), the entire disclosure of which is hereby incorporated by reference for all purposes.

An alternative to the radius of influence approach for human patient or animal tissue deformation modeling is the MFS (Method of Finite Sphere). See in this regard S. De and K. Bathe, “Towards an Efficient Meshless Computational Technique: The Method of Finite Spheres,” Engineering Computations, Vol. 28, No 1/2, pp 170-192, 2001, the entire disclosure of which is hereby incorporated by reference for all purposes. The MFS is a computationally efficient approach with an assumption that only local deformation around the tool-tissue contact region is significant within the organ. See in this regard J, Kim, S. De, M. A. Srinivasan, “Computationally Efficient Techniques for Real Time Surgical Simulations with Force Feedback” IEEE Proc. 10th Symp. On Haptic Interfaces For Virt. Env. & Teleop. Systems, 2002, the entire disclosure of which is hereby incorporated by reference for all purposes. Especially when the size of the organ is large compared t to the tool tip, it may be assumed that the deformation zone is localized within a “region of influence” of the surgical tool tip, namely zero displacements are assumed on the periphery of the “region of influence” of the surgical tool-tip. This technique results in a dramatic reduction in the simulation time for massively complex organ geometries.

An exemplary implementation of the MFS based tissue deformation model in open surgery simulation can employ four major computational steps:
1) Detect the collision of the tool tip with the organ model,
2) Define the finite sphere nodes,
3) Compute the displacement field with approximation, and
4) Compute the interaction force at the surgical tool tip.

For the collision detection of tool and organ, the methods described above can be applied. Also suitable for simulation implementation in at least certain exemplary embodiments of the methods and systems disclosed here is a hierarchical Bonding Box tree method as disclosed, for example, in Ho, C.-H., Computer Haptics: Rendering Techniques for Force-Feedback in Virtual Environments, PhD Thesis, MIT Research Laboratory of Electronics (Cambridge, Mass.) p. 127 (2000), the entire disclosure of which is hereby incorporated by reference for all purposes, or GJK algorithm as disclosed, for example, in G. V. D. Bergen, “A Fast and Robust GJK Implementation for Collision Detection of Convex Objects,” http://www.win.tue.nl/˜gino/solid/igt98convex.pdf, the entire disclosure of which is hereby incorporated by reference for all purposes.

Upon detecting the collision of the tool tip with the organ model, the nodes and distribution of the finite spheres can be determined. A finite sphere node is placed at the collision point. Other nodes are placed by joining the centroid of the triangle with vertices and projecting on to the surface of the model using the surface normal of the triangle. The locations of the finite sphere nodes corresponding to a collision with every triangle in the model are precomputed and stored, and may be retrieved quickly during the simulation. Another way to define the nodes is to use the same finite sphere distribution patterns projected onto the actual organ surface in the displacement field with respect to the collision point. The deformation and displacement of organ surface and the interaction force at the tool tip are computed and the graphics model is then updated for the visualization display. During this process, coarse global model and fine local model can be also considered in tissue deformation model implementation for the purpose of computational efficiency improvement. Finer resolution of triangle mesh can be achieved by a sub-division technique within the local region of the tool tip collision point. Interpolation functions can be applied to generate smooth deformation fields in the local region.

Regarding tracking magnetically responsive, moveable device(s) employed by a user of a system or method in accordance with the present disclosure, in certain exemplary embodiments the following approach is suitable. Tracking relies on accurate spatial information for discrimination. At each timestep, prior tracks are associated with new measurements. A track has a running probability measure, and part of the temporal algorithm is to update this probability with each associated measurement. Given a track and a new measurement, the first process is to gate the measurement to the track. If the measurement gates, an updated track is created, as shown in Diagram 15.

[image]

The prior track has an associated probability of truth, P(T), and a probability of falsehood P(T)=1−P(T). The prior track probability is updated based on the measurement, which has probability P(M). The new track T* can be hypothesized as that formed by associating the prior track and the new measurement. The value S represents the hypothesis that the prior track and the measurement represent the same object. With this, the probability of T* given T and M can be calculated using conditional probability as follows:
P(T*|T,M)=P(S|T,M)P(T*|S,T,M) (1)

For if T and M do not represent the same object, then T* tautologically is false.

The first of the terms in (1) can be calculated using Bayes' Theorem as follows:

$$P ( S \text{\vert} T , M ) = \frac{P ( T , M \text{\vert} S ) P ( S )}{P ( T , M \text{\vert} S ) P ( S ) + P ( T , M \text{\vert} \overline{S} ) P ( \overline{S} )} , \qquad ( 2 )$$

where \overline{S} is the hypothesis that S is false, giving
P(\overline{S})=1−P(S) (3)

Equation (2) can be expressed in terms of the association score between the prior track and the current measurement A(T,M), and the false target density, F, as follows:

$$P ( S \text{\vert} T , M ) = \frac{A ( T , M ) P ( S )}{A ( T , M ) P ( S ) + FP ( \overline{S} )} , \qquad ( 4 )$$

For use in (2) and (4), the a priori probability that the prior track and the current measurement represent the same object can be calculated, as one option, using the false target density, F, the volume of the gate, V_{g}, and the probability of detection, p_{D}, as follows:

$$P ( S ) = \frac{{p}_{D}}{{p}_{D} + {V}_{g} F} . \qquad ( 5 )$$

P(S) can also be calculated using other information (including the terms incorporating the probability of detection), and for this reason, it will be left as an independent parameter, giving the following expression for (4):

$$P ( S \text{\vert} T , M ) = \frac{A ( T , M ) P ( S )}{A ( T , M ) P ( S ) + F ( 1 - P ( S ) )} . \qquad ( 6 )$$

This completes the first term in (1).

To calculate the second term in (1), it can be expressed using Bayes' Theorem as follows:

$$P ( {T}^{*} \text{\vert} S , T , M ) = \frac{P ( T , M \text{\vert} {T}^{*} , S ) P ( {T}^{*} \text{\vert} S )}{P ( T , M \text{\vert} S )} \qquad ( 7 )$$

The first term in the numerator can be written as a function of the recorded probabilities of the prior track and the measurement:
P(T,M|T*,S)=P(P(T)=p_{T}P(M)=p_{M}|T*,S) (8)

Assume a linear PDF for both the prior track and the measurement probability, that is,
P(P(T)=p_{T}|T)=2p_{T}δ, (9)
where δ is a small representative volume in state space. And
P(P(M)=p_{M}|M)=2p_{M}δ (10)

Using T*

[symbol]

T,M,
P(T,M|T*,S)=4p_{T}p_{M}δ² (11)

Let N be the number of types of objects potentially in the scene. Then the a priori probability of T* is 1/N, giving

$$\begin{matrix}P ( {T}^{*} \text{\vert} S ) = \frac{1}{N} \\ and & ( 12 ) \\ P ( {\overline{T}}^{*} \text{\vert} S ) = \frac{N - 1}{N} . & ( 13 )\end{matrix}$$

The denominator in (7) can be written as
P(T,M|S)=P(T,M|T*,S)P(T*|S)+P(T,M|\overline{T}*,S)P(\overline{T}*|S) (14)

Assuming an equally distributed, linear PDF,

$$\begin{matrix}P ( T \text{\vert} {\overline{T}}^{*} , S ) = \frac{2}{N - 1} ( 1 - {p}_{T} ) δ \\ and & ( 15 ) \\ P ( M \text{\vert} {\overline{T}}^{*} , S ) = \frac{2}{N - 1} ( 1 - {p}_{M} ) δ \\ So that & ( 16 ) \\ P ( T , M \text{\vert} S ) = 4 {p}_{T} {p}_{M} {δ}^{2} \cdot \frac{1}{N} + 4 ( N - 1 ) ( 1 - {p}_{T} ) ( 1 - {p}_{M} ) {δ}^{2} \cdot \frac{1}{{N ( N - 1 )}^{2}} & ( 17 )\end{matrix}$$

This allows (7) to be written as

$$P ( {T}^{*} \text{\vert} S , T , M ) = \frac{( N - 1 ) {p}_{T} {p}_{M}}{1 - {p}_{T} - {p}_{M} + N {p}_{T} {p}_{M}} , \qquad ( 18 )$$

which allows (1) to be calculated using (6) and (18) as follows:

$$P ( {T}^{*} \text{\vert} T , M ) = \frac{A ( T , M ) P ( S )}{A ( T , M ) P ( S ) + F ( 1 - P ( S ) )} \cdot \frac{( N - 1 ) {p}_{T} {p}_{M}}{1 - {p}_{T} - {p}_{M} + N {p}_{T} {p}_{M}} . \qquad ( 19 )$$

Further regarding suitable control mechanisms and algorithms for certain exemplary embodiments of the methods and systems disclosed here, the controller may be composed of three main parts: tool posture and position sensing, mobile stage control and magnetic force control. As discussed above, FIG. 5 shows a suitable control architecture. Two modules are shown in this control system configuration: mobile stage control and magnetic force generation. The desired position signal is provided by means of a vision-based tool-tracking module in the surgery simulator. The desired force resulting from tool-tissue interaction is computed using the appropriate virtual environment models, e.g., a human patient tissue model. The desired force vector is realized by adjusting the distribution of the spatial electromagnetic field and the excitation currents in the field winding array.

Regarding detection devices suitable for the systems and methods disclosed here, it is required that sufficient sensory information be provided for the magnetic haptic control system. The sensory measurement should have good accuracy and bandwidth in data acquisition processing. Live video cameras and magnetic sensors, such as Hall sensors, can be used together, for example, to capture the surgical tool (or other device) motion and posture variations. Cameras can provide spatial information of tool-tissue interaction in a relatively low bandwidth, and Hall sensors can provide high bandwidth in a local control loop of the haptic system. As discussed above, in certain exemplary embodiments the stator is supported by a mobile stage to expand the effective motion range or operating space of the haptic system. It is desirable to control the mobile stage so that the electromagnetic stator can follow the magnetized tool such that the moveable device, e.g., the surgery tool tip, stays close to the central point of the electromagnetic field, and hence is subjected to sufficient magnetic interaction force (attractive and/or repulsive). Position sensors can provide the relative position measurement of the surgical tool with respect to the center position of the stator field. Various known control approaches are applicable to this tracking problem. Diagram 16 shows a tracking control framework for a mobile stage of an actuator of a method or system in accordance with the present disclosure, where a traditional PID controller is used in the feedback control loop. The dynamics, particularly the mass of the electromagnetic stator, will affect the tracking performance. Linear or step motors can be used for actuation of the precision mobile stage.

[image]

Further regarding an implementation for surgical simulation, Diagram 17 shows a suitable embodiment of software architecture of MFS implementation for surgical simulation, having four major components: 1) tissue deformation model (200 Hz), 2) common database for geometry and mechanical properties), 3) haptic thread (1 KHz) and interface, and 4) visual thread (30 Hz) and display. The haptic update rate in such embodiments is dependent on a specific haptic device referred to here as a Maglev Haptic System. It is desirable to use 1 KHz update rate to realize good haptic interaction in the simulation. If the underlying tissue model has slower responses than the haptic update rate, a force extrapolation scheme and a haptic buffer can be used in order to achieve the required update rate. The tissue model thread runs at 200 Hz to compute the interaction forces and send them to the haptic buffer. The haptic thread extrapolates the computed forces, e.g., to 1 KHz, and displays them through the haptic device. A special data structure such as Semaphore may be required to prevent the crash of the variables during a multithreading operation.

For more complex tissue geometries a localized version of the MFS technique can be used with an assumption that the deformations die off rapidly with increasing in distance from the surgical tool tip. A major advantage of this localized MFS technique is that it is not limited to linear tissue behavior and real time performance may be obtained without using any pre-computations.

[image]

In certain exemplary embodiments wherein the system or method renders an articulated rigid body, a rendering engine for the articulated rigid body, such as manipulators can be divided into front end and back end. The computation intensive tasks such as dynamic simulation, collision reasoning and the control system for the robot or other sarticulated rigid body reside in the back end. The front end is responsible for rendering the scene and the graphical user interface (GUI).

A point-polygon data structure can be used to describe the objects in the system. Front end and back end each has a copy of such data, in a slightly different format. The set of data in the front end is optimized for rendering. A cross platform OpenGL based rendering system can be used and the data in the front end is arranged such that OpenGL can take it without conversion. This can work well for the rendering of a robotic system, for example, even though the data was duplicated in the memory. For surgical simulation, however, the amount of data needed to describe the organs inside a human body is typically much larger than a man made object; therefore it is critical to conserve the memory usage for such tasks. In that case the extra copy of data in the front end can be eliminated and the back end data is dual use. That is, the point-polygon data in the back end will be optimized for both rendering and back end tasks such as collision reasoning.

For rendering an articulated rigid body, the point-polygon data is fixed for the whole duration of the simulation. The motion of the robot is described by the transformation from link to link. The “display list” mechanism in OpenGL can be used, which groups all the OpenGL commands in each link. For rendering, the OpenGL commands are called only the first time, with the commands stored in the display list. From the second frame on, only the transformations between links are updated. This can give high frame rates for rendering an articulated rigid body but may not be suitable for deformable objects in certain embodiments, where location of the vertices or even the number of vertices and polygons can change.

Further regarding the rendering of virtual soft tissue, e.g., in virtual contact with a tool, e.g., a scalpel or other surgical implement, etc. certain exemplary embodiments implement a mechanism referred to a “vertex arrays” method. Considering Diagram 18 and the following point-polygon data.

[image]

Diagram 18 illustrates the point-polygon data structure and OpenGL calls needed to render it. There are six vertices shared by two polygons. The vertices are recorded as:

$$GL\_FLOAT vertices [ 18 ] = \{ \begin{matrix}0.0 , 0.0 , 0.0 & 1.0 , 0.0 , 0.0 , \\ 1.0 , 1.0 , 0.0 & 0.0 , 1.0 , 0.0 \\ 2.0 , 0.5 , 0.0 & 2.0 , 1.5 , 0.0\end{matrix} \}$$

and the polygons are represented as:

| | | |
|---|---|---|
| GL_INT polygons[8] = { | 0, 1, 2, 3, | 1, 4, 5, 2} |

the surface normal for each vertices is (0.0, 0.0, 1.0).
To render these two polygons, the native OpenGL commands would be
for (int poly=0; poly<2;poly++)
{

glBegin(GL_POLYGON);
for(int vert=0; vert<4; vert++)
{

glNormal3f(0.0, 0.0, 1.0);
glVertex3fv(3*vertices[polygons[4*poly+vert]]);

}
glEnd( );

}

For each vertex, there will be at least one glNormal*( ) and glVertex*( ) calls. If texture mapping is needed, there will also be a glTexCoord*( ) call to specify texture coordinates. The numbers of polygons for describing internal organs for surgical simulation are typically in the millions and reducing the number of OpenGL calls will improve the performance. Display list can be used to store and pre-compile all the gl*( ) calls and improve the performance. However, the display list will record the parameters to the gl*( ) calls as well, which cannot be changed efficiently, and it is desireable in certain exemplary embodiments to be able to change the positions of the vertices or add and remove polygons for (virtual) tissue deformation and cutting. To use vertex arrays, first activate arrays such as vertices, normals and texture coordinates. Then pass array address to the OpenGL system. Finally the data is dereferenced and rendered. Using the above data as an example, the corresponding code would be:

// Step 1, Activate Arrays
glEnableClientState( GL_VERTEX_ARRAY);
glEnableClientState( GL_NORMAL_ARRAY);
glEnableClientState( GL_TEXTUXE_COORD_ARRAY);
// Step 2, assign pointers
glVertexPointer( 3, GL_FLOAT, 0, vertices);
glNormalPointer( GL_FLOAT, 0, normals);
glTexCoordPointer( 2, GL_FLOAT, 0, texCoords);
// Step 3, dereferencing and rendering
glDrawElements(GL_QUADS, 8, GL_UNSIGNED_BYTE, polygons);

Only step 3 needs to be executed at frame rate, which is just one function call compared with 28 calls (3 per vertex plus glBegin( ) and glEnd( ) as described earlier. Also, OpenGL only sees the pointers we passed in on step 2. If the vertices changed, the pointer would still be the same and no extra work is needed. If number of vertices or number of polygons has changed, we may need to update step 2 with new pointers. In certain exemplary embodiments it is possible to gain more performance by triangulating the polygons. The vertex array scheme works best for one kind of shape throughout the data set. In that regard, those skilled in the art, given the benefit of this disclosure will recognize that is possible to convert a complex shape into a set of simple shapes, e.g., to convert a convex polygon into a triangle mesh.

Further regarding detection of the moveable device(s) of a system or method in accordance with the present disclosure, image differencing can be used for fast special processing for tracking. Image differencing can be used for segmentation, e.g., in an image segmentation module or functionality of the controller. Diagram 21 below, schematically illustrates tracking-system architecture employing segmentation.

[image]

In certain exemplary embodiments motion-based segmentation accommodates that hand tools and other devices employed by the user move relative to a fixed background, and that there may be other items moving, such as the user's hand and background objects. This is especially true for certain exemplary embodiments wherein a webcam is used to track tools. It is possible in certain exemplary embodiments to discriminate the user's hands and tools from a stationary or intermittently changing background. Researchers have reported tracking human hands (see, e.g., J. Letessier and F. Berard, “Visual Tracking of Bare Fingers for Interactive Surfaces,” UIST '04, Oct. 24-27, 2004, Santa Fe, N. Mex., the entire disclosure of which is incorporated herein for all purposes), and Image Differencing Segmentation (IDS) is a suitable method in at least certain exemplary embodiments for identifying image regions that represent moving tools. The IDS technique separates pixels in the image into foreground and background. A model of the background is maintained and a map is calculated in each frame giving the probabilities that the pixels in the current image represent foreground. Thus, a model of the background is maintained, and a foreground probability map is used to extract the foreground from images in real time. On initialization, the first N images in a sequence are averaged to initialize the background model, where N is configurable through the XML file. Thus, on initialization, the tools are ideally not present in the field of view of the camera. However, any error in the background will be removed over time in those embodiments employing an algorithm that continually learns about the background. After initialization, for each pixel in each new image, a difference is calculated between the new image and the background. This difference is then converted into a probability. Both the method of calculating pixel difference and the method of converting this difference into a probability can be configurable through C++ subclassing.

To speed processing, pixel difference is established by normalizing a 1-norm of the channel differences to give a range from zero to one. For RGB video, this difference dₚ is established as follows:

$${d}_{p} = \frac{\vert {r}_{1} - {r}_{0} \vert + \vert {g}_{1} - {g}_{0} \vert + \vert {b}_{1} - {b}_{0} \vert}{765}$$

The pixel-difference method is defined through a virtual function, that can be changed through subclassing to include other methods. One exemplary suitable method is to transform the red, green, and blue channels to give a difference that is not sensitive to intensity changes and robust in the presence of shadows.

In establishing foreground probability, the pixel differences are scaled to a range 0-1. Probability also lies in the range 0-1. So the process of establishing foreground probability is equivalent to mapping 0-1 onto 0-1. This mapping is monotonically increasing—the probability that a pixel is in the foreground should increase as the difference between it and the background increases. Also, the probability should change smoothly as the pixel difference changes. To define this mapping, a family of S-curves can be used, defined through an initial slope, a final slope, a center point, and a center slope. Such S-curves can be constructed in accordance with certain exemplary embodiments of the methods and systems disclosed here, using two rational polynomials. To show these, let two functions have the following twin forms:

$${f}_{L} ( x ) = \frac{{a}_{L , 0} {x}^{2} + {a}_{L , 1} x}{{b}_{L} - x} and {f}_{R} ( x ) = \frac{{a}_{R , 0} {x}^{2} + {a}_{R , 1} x}{{b}_{R} - x}$$

Using these, f_{L}(x) can be used to define the s-curve to the left of the center point and f_{R}(x) can be used to define the curve to the right of the center point. Let c be the center value, sᵢ the initial slope, sc the center slope, and s_{f} the final slope. Then the following constraints yield the following solutions for a_{L,0}, a_{L,1} and b_{L}:

$$\begin{matrix}{f}^{′} ( 0 ) = {s}_{i} & & {a}_{L , 0} = \frac{1 - 4 {c}^{2} {s}_{i} {s}_{c}}{4 c ( c ( {s}_{i} + {s}_{c} ) - 1 )} \\ f ( c ) = \frac{1}{2} & ⇒ & {a}_{L , 1} = \frac{{cs}_{i} ( 1 - 2 {cs}_{c} )}{2 ( 1 - c ( {s}_{i} + {s}_{c} ) )} \\ {f}^{′} ( c ) = {s}_{c} & & b = \frac{c ( 1 - 2 {cs}_{c} )}{2 ( 1 - c ( {s}_{i} + {s}_{c} ) )}\end{matrix}$$

The values of a_{R,0}, a_{R,1} and b_{R} can be solved similarly by replacing c with 1-c, and sᵢ with s_{f}. There are several constraints that must be met on the selection of c, sᵢ, s_{c}, and s_{f}. The denominators of the two twin equations (2) and (3) cannot vanish over the applicable range defining the s-curve. This gives the following constraints, which are applied in the order they are given:

$$0 < c < 1$$

$${s}_{i} < \frac{1}{2 c}$$

$${s}_{f} < \frac{1}{2 ( 1 - c )}$$

$${s}_{c} > max ( \frac{1}{c} - {s}_{i} , \frac{1}{1 - c} - {s}_{f} )$$

Regarding background maintenance, after the foreground probability is established, it is used to update the background model. This is done using the following channel-by-channel formula for each channel in each pixel:
B^{t+1}=α^{t}I^{t}+(1−α^{t})B^{t}

Here B^{t} represents a background pixel at time t, I^{t} represents the corresponding pixel in the new image at time t, and α^{t} is a learning rate that takes on values between zero and one. The higher the learning rate, the faster new objects placed in the scene will come to be considered part of the background. The learning parameter is calculated on a pixel-by-pixel basis using two parameters that are configurable through XML. These are the nominal high learning rate, and
\hat{α}_{H}
the nominal high learning rate, and
\hat{α}_{L}
the nominal low learning rate. These nominal values are the learning rate for background and foreground, respectively, assuming a one-second update rate. In general, the time step is not equal to one second. To calculate learning rates for an arbitrary time step At, the following formulas can be used:
α_{H}=1−(1−\hat{α}_{H})^{Δt}
α_{L}=1−(1−\hat{α}_{L})^{Δt}

These values are then used to calculate the actual learning rate as a function of foreground probability as follows:
α^{t}=α_{H}−p(α_{H}−α_{L})

This value, calculated on a pixel-by-pixel basis, is then used in the channel-channel equation above.

Further regarding certain exemplary embodiments wherein a webcam or the like is employed as the detector or as part of the detector for tracking a moveable device in the operating space, thresholding in RGB space may not in some instances produce optimal results, if partitioning in RGB space is not robust to specular light intensity which can vary greatly as a function of distance from the light source. In certain exemplary embodiments this can be improved at least in part by a new class for segmenting in HSI (Hue, Saturation, Intensity). In general, HSI space is easy to partition into contiguous blocks of data where light variability is present. A class called EcRgbToHsiColorFilter was implemented that converts RGB data values into HSI space. The class is subclassed from EcBaseColorFilter and it is stored in an EcColorFilterContainer. The color filter container holds any type of color filter that subclasses the EcBaseColorFilter base class. The original image is converted to HSI using the algorithm described above. This is then segmented based on segmentation regions on three dimensions. Each segmentation region defines a contiguous axis-aligned bounding box. The boxes can be used for selection or rejection. As such, the architecture accommodates any number of selection and rejection regions. Since defining these regions is a time consuming task, the number of boxes can be reduced or minimized. Thus, an original image can be converted to HSI, then segmented based on one or more selection and deselection regions. Finally, the remaining pixels are blobbed, tested against min/max size criterion and selected for further processing.

In general, unless expressly stated otherwise, all words and phrases are used above and in the following claims have all of their various different meanings, including, without limitation, any and all meaning(s) given in general purpose dictionaries, and also any and all meanings given in science, technology, medical or engineering dictionaries, and also any and all meanings known in the relevant industry, technological art or the like. Thus, where a term has more than one possible meaning relevant to the inventive subject matter, all such meanings are intended to be included for that term as used here. In that regard, it should be understood that if a device, system or method has the item as called for in a claim below (i.e., it has the particular feature or element called for, e.g., a sensor that generates signals to a controller), and also has one or more of that general type of item but not as called for (e.g., a second sensor that does not generate signals to the controller), then the device, system or method in question satisfies the claim requirement. The one or more extra items that meet the language of the claim are to be simply ignored in determining whether the device, system or method in question satisfies the requirements of the claim. In addition, unless stated otherwise herein, all features of the various embodiments disclosed here can be, and should be understood to be, interchangeable with corresponding features or elements of other disclosed embodiments.

In the following claims, definite and indefinite articles such as “the,” “a,” “an,” and the like, in accordance with traditional patent law and practice, mean “at least one.” Thus, for example, reference above or in the claims to “a sensor” means at least one sensor.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims

What is claimed is:

1. A haptic feedback system comprising:
a. a moveable device comprising a permanent magnet and moveable with at least three degrees of freedom in an operating space;
b. a display device operative at least partly in response to display signals to present a dynamic virtual environment corresponding at least partly to the operating space;
c. an actuator comprising
a mobile stage having a support controllably moveable in at least two dimensions in response at least in part to actuator control signals, and
a stator supported by the support for controlled movement in at least two dimensions, comprising an array of multiple, independently controllable electromagnet coils at spaced locations and operative by selectively energizing at least a subset of the electromagnetic coils, in response at least in part to haptic force signals, to generate a net magnetic force on the moveable device in the operating space;
d. a detector operative to detect at least the position of the moveable device in the operating space and to generate corresponding detection signals; and
e. a controller operative to receive detection signals from the detector and to generate corresponding
actuator control signals to the actuator to at least partly control positioning of the support,
haptic force signals to the actuator to at least partly control generation of a net magnetic force on the moveable device, and
display signals to the display device.

2. A haptic feedback system in accordance with claim 1 wherein the display device is operative to present a virtual environment that is humanly perceptible as a 2D virtual environment.

3. A haptic feedback system in accordance with claim 1 wherein the display device is operative to present a virtual environment that is humanly perceptible as a 3D virtual environment.

4. A haptic feedback system in accordance with claim 1 wherein the display device is operative to present a virtual environment that simulates assembly of components.

5. A haptic feedback system in accordance with claim 1 wherein the display device is operative to present a virtual environment that simulates a human surgical operation.

6. A haptic feedback system in accordance with claim 1 wherein the operating space is at least as large as a human torso.

7. A haptic feedback system in accordance with claim 6 in which the actuator is operative to generate a net magnetic force on the moveable device at any location in the operating space, which at least at maximum strength is a humanly detectable force on the moveable device.

8. A haptic feedback system in accordance with claim 1 wherein the display device comprises a screen selected from an LCD screen, a CRT and a plasma screen.

9. A haptic feedback system in accordance with claim 1 wherein the display device is operative to present a stereoscopic or autostereoscopic display of the virtual environment.

10. A haptic feedback system in accordance with claim 1 wherein the net magnetic strength has controllable strength and vector characteristics for haptic force feedback corresponding to virtual interaction of the moveable device with a feature of the virtual environment.

11. A haptic feedback system in accordance with claim 1 wherein the actuator is operative in response to control signals from the controller to generate a dynamic net magnetic force during movement of the movable device in the operating space corresponding to virtual interaction of the moveable device with features of the virtual environment.

12. A haptic feedback system in accordance with claim 1 wherein the actuator is operative in response to control signals from the controller to generate a net magnetic force which varies with time between attractive and repulsive.

13. A haptic feedback system in accordance with claim 1 wherein the moveable device has six degrees of freedom.

14. A haptic feedback system in accordance with claim 1 wherein the moveable device is untethered.

15. A haptic feedback system in accordance with claim 1 wherein the stator has at least three electromagnet coils

16. A haptic feedback system in accordance with claim 1 wherein the stator has electromagnet coils spaced on a concave surface.

17. A haptic feedback system in accordance with claim 1 wherein the virtual environment includes an icon corresponding to the position of the moveable device in the operating space.

18. A haptic feedback system comprising:
a. a moveable device moveable with at least three degrees of freedom in an operating space;
b. a display device operative at least partly in response to display signals to present a dynamic virtual environment corresponding at least partly to the operating space;
c. an actuator comprising
a mobile stage having a support controllably moveable in at least dimensions in response at least in part to actuator control signals, and
a stator supported by the support for controlled movement in at least two dimensions, comprising an array of multiple, independently controllable electromagnet coils at spaced locations and operative by selectively energizing at least a subset of the electromagnetic coils, in response at least in part to haptic force signals, to generate a net magnetic force on the moveable device in the operating space; and
d. a detector operative to detect at least the position of the moveable device in the operating space and to generate corresponding detection signals; and
e. a controller operative to receive detection signals from the detector and to generate corresponding
actuator control signals to the actuator to at least partly control positioning of the support,
haptic force signals to the actuator to at least partly control generation of a net magnetic force on the moveable device, and
display signals to the display device.

19. A haptic feedback system in accordance with claim 18 wherein the moveable device is untethered.

20. A haptic feedback system in accordance with claim 18 wherein the stator is operative to impress magnetism at least temporarily in the moveable device and then to apply repulsive magnetic force against the movable device.

21. A haptic feedback system in accordance with claim 18 wherein the operating space is at least as large as a human torso.

22. A haptic feedback system in accordance with claim 18 further comprising position sensors operative to detect the position of the mobile stage and to generate corresponding mobile stage position signals to the controller.

23. A haptic feedback system comprising:
a. a moveable device comprising a permanent magnet and moveable with at least three degrees of freedom in an operating space;
b. a display device operative at least partly in response to display signals to present a dynamic virtual environment corresponding at least partly to the operating space;
c. an actuator comprising a stator comprising an array of multiple, independently controllable electromagnet coils at spaced locations and operative by selectively energizing at least a subset of the electromagnet coils, in response at least to haptic force signals, to generate a net magnetic force on the moveable device in the operating space; and
d. a detector operative to detect at least the position of the moveable device in the operating space and to generate corresponding detection signals; and
e. a controller operative to receive detection signals from the detector and to generate corresponding
haptic force signals to the actuator to at least partly control generation of a net magnetic force on the moveable device, and
display signals to the display device.

24. A haptic feedback system in accordance with claim 23 wherein the moveable device is untethered.

25. A haptic feedback system in accordance with claim 23 wherein the operating space is at least as large as a human torso.
